(19) United States
(12) Patent Application Publication
(10) Pub. No.: US 2026/0310636 A1
(43) Pub. Date: Oct. 8, 2026

(54) Systems and Methods for Digitally Interpreting a Linguistic Section of a Digital File to Extract and Categorize Specification Parameters for Validation Mapping

(71) Applicant: Veeva Systems Inc., Pleasanton, CA (US)

(72) Inventors: Joby George, Marlboro Township, NJ (US); Katherine Noel Cohen, Santa Barbara, CA (US)

(73) Assignee: Veeva Systems Inc., Pleasanton, CA (US)

(21) Appl. No.: 19/640,196

(22) Filed: Apr. 6, 2026

Related U.S. Application Data
(60) Provisional application No. 63/783,425, filed on Apr. 4, 2025.

(51) Int. Cl. G06F 16/21; G06F 16/248

(52) U.S. Cl. CPC G06F 16/213; G06F 16/248

(57) ABSTRACT

A method for generating a test specification data schema includes receiving a source file including a linguistic section determining a first portion of the text data identifies a first event. The method further includes outputting a first request to a partner computing system. The method further includes receiving an indication of a second event included in a second portion of the text data from the partner computing system. The method further includes generating a test specification data schema based on the first event and the second event. The method further includes receiving a second request to generate a test specification data record. The method further includes selecting the test specification data schema from the repository based on the first request. The method further includes instantiating the test specification data record based on the test specification data schema.

### CROSS REFERENCE TO RELATED APPLICATIONS

This application claim priority to of U.S. Provisional Patent Application No. 63/783,425, filed on Apr. 4, 2025, which is incorporated herein by reference in its entirety.

### TECHNICAL FIELD

The present disclosure relates to systems and methods for digitally interpreting a linguistic section of a digital file to extract and categorize specification parameters for validation mapping.

### BACKGROUND

Researchers, scientists, industry players, academics, government regulators, and other stakeholders are increasingly in need of efficient and simple ways to extract data from large, complex product specifications into a structured format.

### SUMMARY

One embodiment relates to a method for generating a test specification data schema. The method includes receiving a source file including a linguistic section. The source file is an unstructured data file type. The method further includes parsing the linguistic section to generate a structured text data. The method further includes determining a first portion of the structured text data identifies a first event. The method further includes generating a first request including a query and at least one of: the source file or the text data. The method further includes outputting the first request to a partner computing system. The method further includes receiving an indication of a second event included in a second portion of the text data from the partner computing system. The method further includes validating the first and second events against a parent event schema. The method further includes determining the first event is complete. The method further includes determining the second event is complete. The method further includes generating a test specification data schema based on the first event and the second event. The method further includes storing the test specification data schema in a repository of the provider computing system. The method further includes receiving a second request to generate a test specification data record. The method further includes selecting the test specification data schema from the repository based on the first request. The method further includes instantiating the test specification data record based on the test specification data schema.

Another embodiment relates to a method for generating a product specification data schema. The method includes receiving a source file including a linguistic section. The source file is an unstructured data file type. The method further includes parsing the linguistic section to generate a structured text data. The method further includes selecting at least one test specification data schema from a first repository. The method further includes determining a first portion of the text data identifies a first product partition. The method further includes determining a second portion of the text data assigns a first test to the first product partition based on the at least one test specification data schema. The method further includes generating a first request including a query and at least one of: the source file or the text data. The method further includes outputting the first request to a partner computing system. The method further includes receiving a first indication of a second product partition included in a third portion of the text data from the partner computing system and a second indication of a second test assigned to the second product partition included in a fourth portion of the text data. The method further includes determining the first product partition is complete. The method further includes validating the first and second product partitions against a parent event schema. The method further includes determining the second product partition is complete. The method further includes generating a product specification data schema based on the first product partition, the first test assigned to the first product partition, the second product partition, and the second test assigned to the second product partition. The method further includes storing the product specification data schema in a second repository of the provider computing system. The method further includes receiving a second request to generate a product specification data record. The method further includes selecting the product specification data schema from the second repository based on the second request. The method further includes instantiating the product specification data record based on the product specification data schema.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a component diagram of a digital data interpretation and processing system, according to an example embodiment.

FIG. 2 is a flow diagram of a method for generating a portable file, according to an example embodiment.

FIG. 3 is a flow diagram of a method for generating data records based on the portable file, according to an example embodiment.

FIG. 4 is a flow diagram of a method for generating a test specification data schema, according to an example embodiment.

FIG. 5 is a flow diagram of a method for generating a product specification data schema, according to an example embodiment.

FIG. 6 is a flow diagram of a method for instantiating a product specification data record, according to an example embodiment.

FIGS. 7A-7C is a record diagram of a portable data schema, according to an example embodiment.

FIGS. 8A-8F is illustrations of some aspects of a user interface generated by the digital data interpretation and processing system of FIG. 1 to build or generate a test specification data schema, according to an example embodiment.

FIGS. 9A-9C is illustrations of some aspects of a user interface generated by the digital data interpretation and processing system of FIG. 1 to build or generate a product specification data schema, according to an example embodiment.

### DETAILED DESCRIPTION

Referring generally to the figures, systems and methods digitally interpreting a linguistic section of a digital file to generate transportable or portable data records are disclosed. The systems and methods described herein provide for simpler and faster testing specification upload, download, and portability across various databases and systems, thereby providing for better document management systems. For instance, test specifications (also referred to as test definitions) can be complex documents including hundreds of pages, multiple tables and charts defining the testing procedures, and hundreds of definitions. In this regard by utilizing a portable data schema to store the test specification, as compared to as a document or a static data schema, the systems and methods described herein provide for faster upload, download, and processing of testing specifications. In one example, testing specifications may be updated over time and require new data records to be generated. This can be an arduous process that takes a lot of time and processing power to enter each change. In comparison, the present systems and methods utilize a portable file (e.g., a zip file) that includes the changes to the test specification as data records, thereby saving on processing power by requiring less user input and communication with a client computing device.

The systems and methods described herein provide for simpler and faster source file processing and schema generation, and thereby provide a technical improvement to slow and cumbersome document processing systems. For example, by utilizing a text highlighter on a user interface for the intake of unstructured text data, the present systems can programmatically map unstructured strings to structured schema objects and bypass the slow process of manually reading through the source file and parsing the important information out, thereby shortening the time it takes for data to be processed. This specific UI-to-backend mapping reduces memory overhead and prevents data-type mismatch errors inherent in manual entry.

Additionally, because the systems and methods described herein remove time-consuming and laborious manual readthroughs of unstructured text data case data and then clean the selected text data, the present systems provide for more accurate, less error-prone case data, which allows for quicker, more efficient, and more accurate schema generation. For instance, in typical systems, a user may have to read through unstructured text data and manually add each portion of the test specification or product specification to the system. This is time-consuming and error prone as the user has to manually type in each value. In comparison, the present systems and methods provide an improved user interface in which the user can read through the text data and simply highlight portions that correspond to events or product partitions. Then, the present systems and methods may clean the selected text data (e.g., transform date formats, remove erroneous letters, etc.) and generate the data schemas described herein. By doing so, the present systems and methods provide for more accurate, less error-prone data schemas.

Likewise, because the present systems and methods utilize a partner AI computing system (e.g., that includes an LLM engine) to determine events and product partitions located in the source file, the present systems and methods provide for advanced constraint extraction and logic mapping. For instance, traditional parsing tools struggle to interpret natural language conditions. AI excels at understanding contextual rules and converting them into strict programmatic constraints within a schema. For example, AI systems an recognize phrases like “If the sensor type is thermal, the threshold must be between 10 and 50” and automatically generate complex schema logic (e.g., if/then, allOf, or oneOf operators in JSON Schema). Likewise, AI systems It can accurately infer data types (integer, float, boolean, enum) and formatting constraints (e.g., recognizing that an “Order ID” must match a specific UUID regex pattern) directly from descriptive text Accordingly, by using AI to locate data in the source file, the present systems and methods use a two-tier parsing strategy that provides for more accurate overall data and a simpler, more accurate set of data schemas. By executing a two-tier parsing strategy, namely combining local deterministic parsing with remote probabilistic LLM inference, the system achieves a technical verification of data integrity that exceeds human capability.

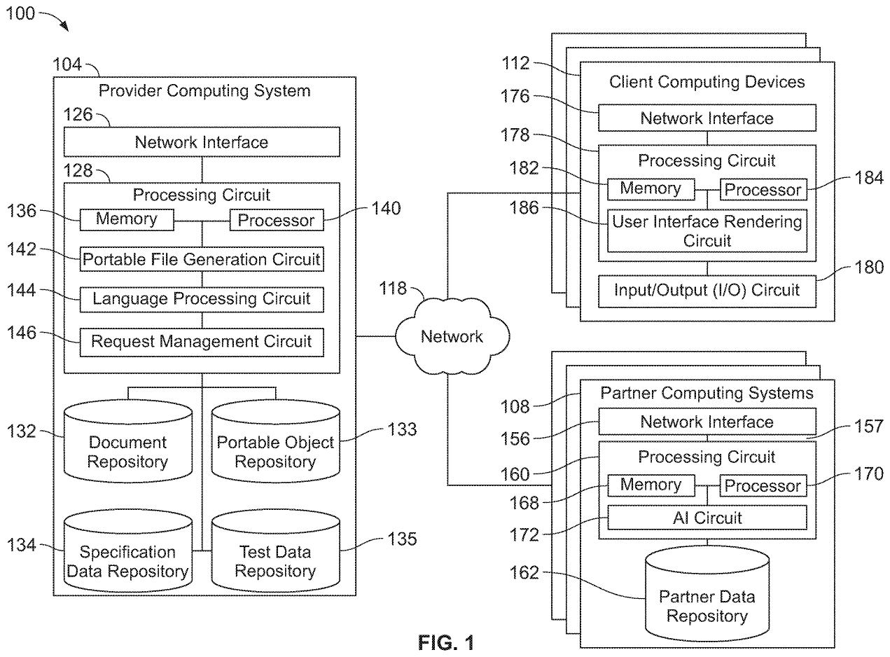

Referring now to FIG. 1, a system 100 for defining and generating specification data schemas or classes (or sub-classes) and test data schemas or classes (or sub-classes), as well generating a portable file based on each is shown, according to an example embodiment. The system 100 includes a provider computing system 104, multiple partner computing systems 108, and multiple client computing devices 112 connected by a secure network (e.g., a network 118).

The network 118 communicably and operably couples the provider computing system 104, the partner computing systems 108, and the client computing devices 112 such that communicable and operable computing may be provided between the provider computing system 104 and the client computing devices 112 over the network 118. In various embodiments, the network 118 includes any combination of a local area network (LAN), an intranet, the Internet, or any other suitable communications network, directly or through another interface.

The provider computing system 104 may be operated and managed by a provider (e.g., a software as a service (SaaS) provider, a cloud services provider, a software provider, a service provider, etc.) and may include a computer system (e.g., one or more servers (e.g., a cloud computing server) each with one or more processing circuits). In some embodiments, the provider computing system 104 may act as a host and provide an application (e.g., a web-based application, a mobile application, etc.) to the client computing devices 112 over the network 118 in response to authenticating the respective computing device 112. For example, the provider computing system 104 may receive authentication data (e.g., a username and corresponding password, a limited-use key, a two-factor authentication code or key, etc.) from one of the client computing devices 112. The provider computing system 104 may then authenticate the client computing device 112 based on the authentication data and provide an application to the client computing device 112 over the network 118. In some examples, the provider computing system 104 may be a multi-tenant system where various elements of hardware and software may be shared by one or more customers. In a multi-tenant system, a user is typically associated with a particular customer. In one example, a user (e.g., of the client computing device 112) could be an employee of one of a number of (pharmaceutical) companies which are tenants, or customers, of the provider computing system 104.

In some embodiments, the provider computing system 104 may run on a cloud computing platform. Users can access content on the cloud independently by using a virtual machine image or purchasing access to a service maintained by a cloud repository provider.

In some embodiments, the provider computing system 104 may be provided as Software as a Service (“SaaS”) to allow users to access the provider computing system 104 with a thin client.

As shown, the provider computing system 104 may include a network interface 126, a processing circuit 128, a document repository 132, a portable object repository 133, a specification data repository 134, and a test data repository 135. In some embodiments, the provider computing system 104 may include an input/output circuit (e.g., similar to (e.g., the same as) an input/output circuit 180 as will described further herein).

The network interface 126 is structured to establish connections with the partner computing systems 108 and the client computing devices 112 by way of the network 118. The network interface 126 includes program logic and/or hardware-based components that connect the provider computing system 104 to the network 118. For example, the network interface 126 may include any combination of a wireless network transceiver (e.g., a cellular modem, a broadband modem, a Bluetooth® transceiver, a Wi-Fi® transceiver, a Li-Fi® transceiver, etc.) and/or a wired network transceiver (e.g., an Ethernet transceiver). In some embodiments, the network interface 126 includes the hardware and machine-readable media structured to support communication over multiple channels of data communication (e.g., wireless, Bluetooth®, near-field communication (NFC). In some embodiments, the network interface 126 includes cryptography logic and capabilities to establish a secure communications session.

The processing circuit 128, as shown, comprises a memory 136, a processor 140, a portable file generation circuit 142, a language processing circuit 144, and a request management circuit 146. The memory 136 includes one or more memory devices (e.g., RAM, NVRAM, ROM, flash memory, hard disk storage, etc.) that store data and/or computer code for facilitating the various processes described herein. That is, in operation and use, the memory 136 stores at least portions of instructions and data for execution by the processor 140 to control the processing circuit 128. The memory 136 may be or include tangible, non-transient volatile memory and/or non-volatile memory. The processor 140 may be implemented as a general-purpose processor, an application specific integrated circuit (ASIC), one or more field programmable gate array (FPGAs), a digital signal processor (DSP), a group of processing components or other suitable electronic processing components.

As described herein, the portable file generation circuit 142 is a circuit or service that is configured to receive product specification data records and test specification data records and generate a portable data record based on each. The portable data record may provide for an easier structure to store the product specification data records and test specification data records and for packaging as a portable file. Accordingly, once the portable file generation circuit 142 has generated the portable data record, the portable file generation circuit 142 may generate a portable file based on the portable data record. For instance, the portable file generation circuit 142 may package each of the components or records of the portable data record into a specific file format (e.g., Zip file) and store the portable file generation circuit 142 in the portable object repository 133. In some embodiments, the portable file generation circuit 142 may be configured to generate a portable data record based on the portable file. In this regard, the portable file generation circuit 142 may generate the portable data record and package the portable data record into the portable file. Likewise, the portable file generation circuit 142 may unpackage a portable file into a portable data record, thereby providing for simpler and faster transportation of the complex data structures described herein.

Still referring to FIG. 1, the language processing circuit 144 is a circuit or service that is configured to translate text data from a first language to a variety of target languages. In some embodiments, the language processing circuit 144 may use a combination of rule-based translations and Machine Learning or Artificial intelligence based learning to perform translations. For instance, the language processing circuit 144 may maintain or communicate with a translation repository (not shown) to maintain single word or phrase translations (e.g., dad→padre), which may be used for translating single terms or phrases of a field. Likewise, the language processing circuit 144 may communicate with the request management circuit 146 to generate translation requests including larger pieces of text or linguistic sections. Then, via the request management circuit 146, the language processing circuit 144 may perform translations from a first language to a target language.

The request management circuit 146 is a circuit or service that is configured to generate and manage request including text queries or prompts. For instance, the request management circuit 146 may be configured to determine a type or classification of the request (e.g., a first type, a second type, a third type, etc.) and generate the request based on the type of the request and one or more sets of data to be included in the query (e.g., an entity vector). Moreover, the request management circuit 146 may retrieve specific sets of data or files based on the request. In some embodiments, the request management circuit 146 may generate the request including the text query and an API key stored in an API repository (not shown) of the provider computing system 104. The API key is a unique identifier, often a string of alphanumeric characters, used to authenticate and authorize access to an API. It acts like a digital password, allowing applications to identify themselves. In this regard, the request management circuit 146 may determine the API key to include in the request based on the customer associated with the query (e.g., from which the query was received or on behalf of who the query is being generated) and the specific partner computing system to which the request is to be output. In that regard, a customer may have a first API key for a first partner computing system 108 and a second, different, API key for a second partner computing system 108. In operation, the query management circuit 124 may receive a request to generate the request; generate the request; and output the request to one of the partner computing systems 108.

In some embodiments, the provider computing system computing system 104 includes an AI model (e.g., neural network model, LLM, etc.) generation circuit or service (not shown) configured to generate, train, and deploy an AI agent or AI model, and includes an AI model execution circuit or service (not shown) configured to execute an AI agent or LLM on the entity extraction computing system 104.

For instance, the AI model generation service (not shown) acts as the development and operational hub for an AI model. In this regard, the AI or LLM generation service may retrieve data from a multitude of sources (e.g., the repositories 132-135, other repositories connected via the network 118, etc.) to then initialize and train a base AI model (which could range from a simple, task-specific deep learning model to a large, transformer-based LLM). Further, the AI model generation service may fine-tune the model on large, annotated datasets specifically curated for the task of entity extraction—identifying and classifying key entities (like names, dates, locations, and organizations) within unstructured text. For instance, the AI model generation service may create, receive, or generate curated datasets where entities have been labeled (e.g., Named Entity Recognition (NER) annotation), and then be trained to identify and classify the key entities. Additionally, the AI model generation service may validate the AI model and perform format conversion for efficiency (e.g., quantization), and the establishment of a versioned model endpoint accessible by the execution environment) to ensure consistency. The AI model generation service thereby ensures the models are continuously monitored, updated, and optimized for accuracy and performance.

In comparison, the AI model execution circuit or service (not shown), is the runtime engine where the deployed models perform their primary function. This circuit may be optimized for low-latency inference, as its role is to execute or deploy an AI model on incoming text queries (e.g., prompts) processed by the provider computing system 104 to generate responses. When a document, email, or a block of text is submitted to the system, the execution service loads the appropriate, deployed AI/LLM agent to analyze the text, leveraging its training to pinpoint specific text spans that correspond to predefined entity types. For example, the AI agent may receive a request requesting text data to be translated from a first language to a second language, and the AI agent may retrieve data associated with the translation (e.g., a source file) and generate a text response associated with the request. In some embodiments, the AI model execution service may have access to the network 118 to generate text responses. Further, the AI model execution service may be scalable and capable of handling a high volume of requests. For instance, the AI model execution service may employ load balancing and auto-scaling groups to dynamically adjust capacity based on the volume of entity extraction requests. Furthermore, it may perform logging and telemetry of inference results, providing the essential feedback loop to the generation service to monitor model performance and identify potential data drift or degradation in real-world accuracy.

Accordingly, while the present application describes outputting text requests to the partner computing system 108, it should be understood that the provider computing system 104 may locally deploy (e.g., on the same server or processing circuit, on a connected server/processing circuit, etc.) an AI agent or model (via the AI model generation service). The provider computing system 104 may then input or provide the requests to the AI agent or AI model execution service, which may return a response file.

Still referring to FIG. 1, the document repository 132 is a repository (e.g., a database) that is structured or configured to receive, store, and manage digital files or documents, such as testing specifications. In this regard, the document repository 132 may receive, store, and manage digital documents. For example, a customer may have a medical product that is manufactured and tested may store a testing specification in the document repository 132. The testing specification may include steps for testing, normal values and ranges for the medical product (e.g., a specific strength of the medical product, a specific color of the medical product), standards that are to be used when testing the medical product, etc. Accordingly, one of the client computing devices 112 may provide the testing specification as a digital file to the provider computing system 104 for storage in the document repository 132. In that regard, the document repository 132 can be structured according to various database types, such as, relational, hierarchical, network, flat, point-in time, and/or object relational. Further, the document repository 132 may include a plurality of nonvolatile/non-transitory storage media such as solid-state storage media, hard disk storage media, virtual storage media, cloud-based storage drives, storage servers, and/or the like.

The portable object repository 133 is a repository (e.g., a database, cloud storage, etc.) that is structured or configured to receive, store, and manage portable data records that define the digital file or documents). For example, the portable object repository 133 may be a portable object repository that stores the portable object data in an object record format. In one example, the portable object record may include 20 tabs or sections, and the portable object data schema may include 20 data objects that correspond to each respective tab or section. To do so, the portable object repository 133 can be structured according to various database types, such as, relational, hierarchical, network, flat, point-in time, and/or object relational.

The product data repository 134 is a repository (e.g., database, cloud storage, etc.) that is structured or configured to receive, store, and manage, product specification data records, product specification data schemas, and other data thereof described herein. For instance, the product data repository 134 may receive a product specification data schemas generated as described with reference to the method 500. To do so, the product data repository 134 can be structured according to various database types, such as, relational, hierarchical, network, flat, point-in time, and/or object relational.

The test data repository 135 is a repository (e.g., database, cloud storage, etc.) that is structured or configured to receive, store, and manage, test specification or definition data records, test specification or definition data schemas, and other data thereof described herein. For instance, the test data repository 135 may receive a test data schema generated as described with reference to the method 400. To do so, the test data repository 135 can be structured according to various database types, such as, relational, hierarchical, network, flat, point-in time, and/or object relational.

In some embodiments, the provider computing system 104 may store data schemas and data records separately. Accordingly, the provider computing system 104 may include a test data record repository (not shown) and a test data schema data repository (not shown), as compared to a test data repository 135 for both. Likewise, the provider computing system 104 may include a product data record repository (not shown) and a product data schema repository (not shown), as compared to a product data repository 134 for both.

Still referring to FIG. 1, the partner computing systems 108 may be managed by third-party partners (e.g., partner company 1, partner company 2, partner computing system xyz, etc.) and can be or include a computing device or system configured to communicate with provider computing system 104 over the network 118. For instance, the partner computing systems 108 can be a server computer system, a gateway computing system, a laptop computer, a desktop computer, and any other network-connected device that can communicate over the network 118. In another example, one of the partner computing systems 108 may be a laptop computer operated by an employee of a partner company. In another example, one of the partner computing systems 108 may be a server of a large language model (LLM) or AI partner company (e.g., Google®, OpenAI®, etc.) that receives requests or prompts (e.g., via an application programming interface (API)).

In operation, the partner computing systems 108 may communicate with the e provider computing system 104 or the client computing devices 112 to send and/or receive one or more electronic communications (e.g., requests, response files, etc.). For instance, the provider computing system 104 may generate a request including a text query, an API key, one or more files, an unstructured source file, and output the request to the partner computing system 108. Then, based on the request, the partner computing system 108 may generate a response file or message and output the response file to the provider computing system 104. In some embodiments, the response file may be a specific file type (e.g., Java Script Object Notation (JSON), XML, CSV, etc.).

In some embodiments, the system 100 may include multiple partner computing systems 108 (e.g., a first partner computing system 108, a second partner computing system 108, and so on). In one example, the provider computing system 104 may send different requests out to different partner computing systems 108. For instance, the provider computing system 104 may output a first request to the first partner computing system 108 (which may be associated with a first AI partner (e.g., Google®)). Then, to perform a quality control (QC) check on the response file received from the first partner computing system 108, the provider computing system 104 may generate a second request (including at least a portion of the first response file) and output the second request to a second partner computing system 108 (which may be associated with a second AI partner (e.g., OpenAI®). In this regard, each request may include a different API key (e.g., a first API key and a second API key).

As shown, the partner computing system 108 includes a network interface 156, a processing circuit 160, and a partner data repository 162. In other embodiments, each partner computing system 108 includes an API gateway circuit (not shown) for processing API calls and requests. In some embodiments, each partner computing system 108 further includes a key repository (not shown) for storing keys and certificates (e.g., AS2 keys, API keys, etc.).

The network interface 156 is structured to establish connections with the provider computing system 104 and/or the client computing devices 112 by way of the network 118. The network interface 156 includes program logic and/or hardware-based components that connect each partner computing system 108 to the network 118. For example, the network interface 156 may include any combination of a wireless network transceiver (e.g., a cellular modem, a broadband modem, a Bluetooth® transceiver, a Wi-Fi® transceiver, a Li-Fi® transceiver, etc.) and/or a wired network transceiver (e.g., an Ethernet transceiver). In some embodiments, the network interface 156 includes the hardware and machine-readable media structured to support communication over multiple channels of data communication (e.g., wireless, Bluetooth®, near-field communication (NFC), or the like). In some embodiments, the network interface 156 includes cryptography logic and capabilities to establish a secure communications session.

The processing circuit 160, as shown, comprises a memory 168 and processor 170. The memory 168 includes one or more memory devices (e.g., RAM, NVRAM, ROM, flash memory, hard disk storage, etc.) that store data and/or computer code for facilitating the various processes described herein. That is, in operation and use, the memory 168 stores at least portions of instructions and data for execution by the processor 170 to control the processing circuit 160. The memory 168 may be or include tangible, non-transient volatile memory and/or non-volatile memory. The processor 170 may be implemented as a general-purpose processor, an application specific integrated circuit (ASIC), one or more field programmable gate array (FPGAs), a digital signal processor (DSP), a group of processing components or other suitable electronic processing components.

The partner repository 162 may be similar or the same as the repositories of the provider computing system 104 and is a repository (e.g., a database, cloud storage, etc.) that is structured or configured to receive, store, and manage files or data of the partner (e.g., response files, requests, etc.). Further, the partner repository 162 can be structured according to various database types, such as relational, hierarchical, network, flat, point-in time, and/or object relational. In some embodiments, the partner repository 162 includes a plurality of nonvolatile/non-transitory storage media such as solid-state storage media, hard disk storage media, virtual storage media, cloud-based storage drives, storage servers, and/or the like.

Still referring to FIG. 1, the client computing devices 112 can each be any type of computing device or computing system. For instance, each client computing device 112 can be one or more of a mobile phone, a tablet computer, a laptop computer, a smart watch, a server computer system, or any other internet-connected device. In operation, the client computing devices 112 may communicate and interface with the provider computing system 104 via the network 118 to provide the digital files and/or portable files for storage therein. As shown, each client computing device 112 may include a network interface 176, a processing circuit 178, and the input/output (I/O) circuit 180.

The network interface 176 structured to establish connections with the provider computing system 104 or the partner computing system 108 by way of the network 118. The network interface 176 includes program logic and/or hardware-based components that connect the client computing devices 112 to the network 118. For example, the network interface 176 may include any combination of a wireless network transceiver (e.g., a cellular modem, a broadband modem, a Bluetooth transceiver, a Wi-Fi transceiver, a Li-Fi transceiver, etc.) and/or a wired network transceiver (e.g., an Ethernet transceiver). In some embodiments, the network interface 176 includes the hardware and machine-readable media structured to support communication over multiple channels of data communication (e.g., wireless, Bluetooth, near-field communication (NFC). In some embodiments, the network interface 176 includes cryptography logic and capabilities to establish a secure communications session.

The processing circuit 176, as shown, comprises a memory 182, a processor 184, and a user interface generation or rendering circuit 186. The memory 182 includes one or more memory devices (e.g., RAM, NVRAM, ROM, flash memory, hard disk storage, etc.) that store data and/or computer code for facilitating the various processes described herein. That is, in operation and use, the memory 182 stores at least portions of instructions and data for execution by the processor 184 to control the processing circuit 176. The memory 182 may be or include tangible, non-transient volatile memory and/or non-volatile memory. The processor 184 may be implemented as a general-purpose processor, an application specific integrated circuit (ASIC), one or more field programmable gate array (FPGAs), a digital signal processor (DSP), a group of processing components or other suitable electronic processing components.

The user interface rendering circuit 186 may be configured to receive a user interface (e.g., a web interface in an HTML file and related files, a downloaded graphical user interface, etc.) from the provider computing system 104 and render the user interface on the client computing device 112 via the I/O circuit 180. In this way, the provider computing system 104 may generate one or more user interfaces and provide the one or more user interfaces to the user interface generation circuit 186 to be rendered on the client computing device 112 (e.g., on a display of the I/O circuit 180 of the client computing device 186).

The I/O circuit 180 is structured to receive communications from and provide communications to the user of the client computing device 112 (e.g., the user). In this regard, the I/O circuit 180 is structured to exchange data with the processing circuit 178 to provide output to the user and to receive input from the user. As a result, the I/O circuit 180 may include a display that may be manipulated by the application. In some embodiments, the I/O circuit 180 may also include a keyboard, a mouse, a joystick, a touch screen, touch areas, soft keys, a microphone, a speaker, a vibration mechanism, a sensor, a RFID scanner, or other input/output devices described herein.

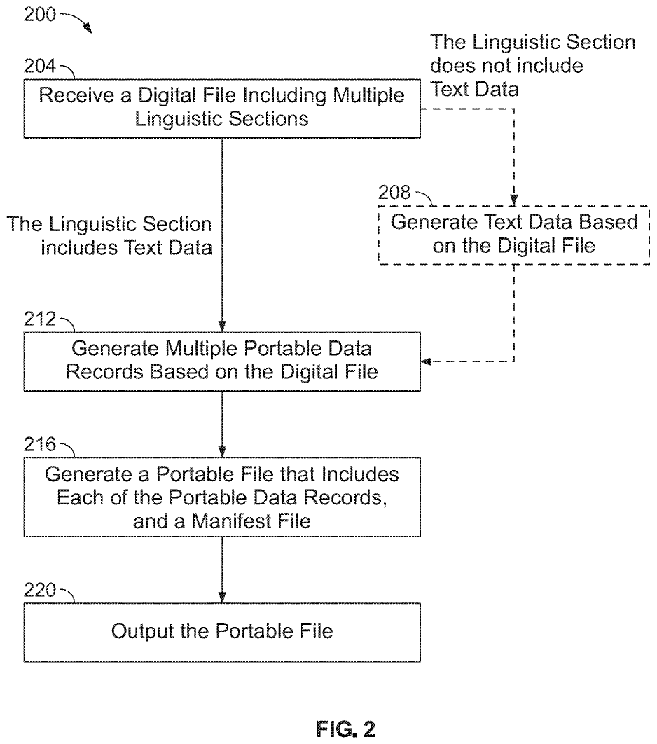

Referring now to FIG. 2, a method 200 of digitally interpreting a linguistic section of a digital file to generate portable data records is shown, according to an example embodiment. Method 200 can be carried out by the system of FIG. 1. More particularly, the method 200 can be carried out by the processing circuit 128 of the provider computing system 104 and through communication with the client computing devices 112.

Method 200 commences at step 204 at which the provider computing system 104 receives a digital file including at least one linguistic section (e.g., sections, such as paragraphs, including multiple words, tables, values, and/or terms). For example, a digital file may be a Word processor file (e.g., a .docx file), a PDF file, a spreadsheet file (e.g., an Excel file), and the like. In one example, the digital file may be a test specification file that is structured as a word processor file. In another example, the digital file may be a test specification file including multiple sections therein and that is structured as a PDF file

The linguistic section(s) may include words and terms defining testing procedures, corrective procedures, specific ranges, specific values, and the like. In some embodiments, the linguistic section may include text data. In other embodiments, the linguistic section may not include text data and may be an image or PDF file.

If the linguistic section(s) of the digital file do not include text data, the provider computing system 104 may proceed to optional step 208 at which the provider computing system generates text data based on the digital file (e.g., based on the linguistic sections of the digital file). For instance, the provider computing system 104 may perform Optical character recognition (OCR), Regex, natural language processing (NLP), or other text recognition methods on the linguistic sections of the digital file. In one example, the provider computing system 104 may use OCR to generate text data based on the linguistic sections and then add the text data to the digital file. In another example, the provider computing system 104 may use OCR to generate text data based on the linguistic sections and then generate a text file including the text data therein.

In some embodiments, the text data may be generated in a first language. Then, at or after step 208, the provider computing system 104 may translate the text data from the first language to a second language. For instance, the digital file may include a linguistic section which is in French. Accordingly, the text data may be generated in French and then translated to English.

If at step 204, the digital file includes text data, the method 200 may proceed to step 212. Likewise, once the provider computing system 104 has generated the text data at step 208, the method 200 may proceed to step 212. At step 212, the provider computing system 104 may determine multiple portable data records based on the text data. In some embodiments, determining the portable data record comprise two steps or portions: 1) determining, by the provider computing system 104, portable data records based on the text data and a portable data schema, and 2) receiving user input including portable data records. In some embodiments, each step may be performed separately. For instance, the provider computing system 104 may determine portable data records based on the text data and a portable data schema at a first time (e.g., at step 212), and then user input including portable data records at a later step (e.g., after step 212).

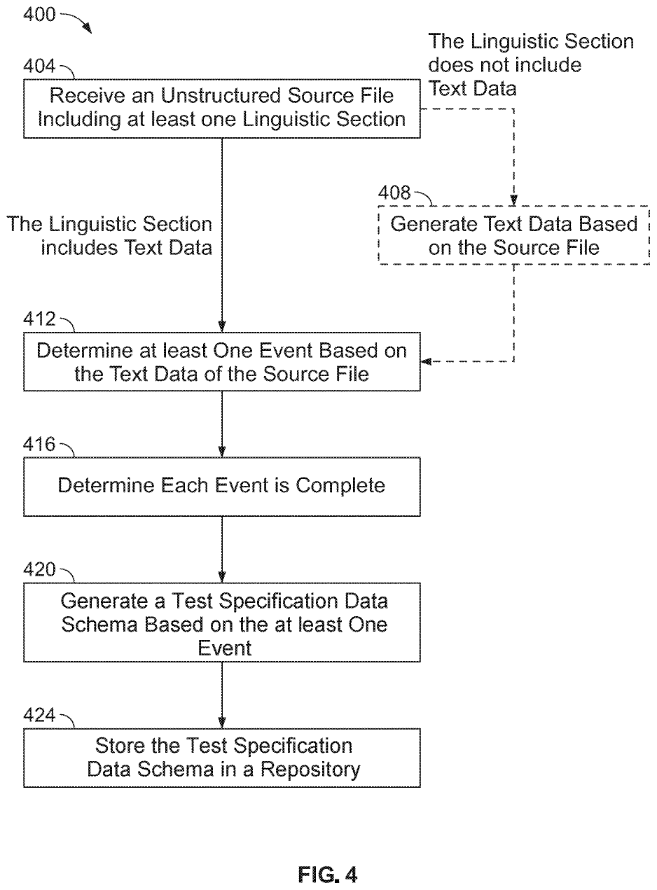

The portable data schema may identify the multiple types of data included in one or more of the portable data records. In some embodiments, the portable data schema may include three types of portable data objects including a specification data unit data object, a sample plan data object, and a test definition unit data object. FIGS. 4A-4B show an example portable data schema including the specification data unit data object, a sample plan data object, and the test definition unit data object.

In this regard, the provider computing system 104 may determine portable data records by parsing the text data for words and terms that correspond to each of the fields of the portable data schema. In one example, the provider computing system 104 may parse the text data for a word or term corresponding to a test definition step (e.g., “Step 1”, etc.). In some embodiments, the provider computing system 104 may search or parse the text data for terms of various repositories (not shown) of the provider computing system 104. In some embodiments, the provider computing system 104 may utilize a large language model (LLM) (e.g., Google Gemini®, OpenAI Chat GPT®, an internal LLM, etc.) to search the text data for potential pieces of case data based on the data stored in the repositories of the provider computing system 104.

In this regard, the provider computing system 104 may parse the text data and determine portions of the portable data records based on the text data. In one example, the provider computing system 104 may determine a first field of a specification data unit data record, a second field of the specification data unit data record, and a third field of the specification data unit data record. Once the provider computing system 104 has determined portions of portable data records, the provider computing system 104 may provide the digital file, the text data, and the portions of the portable data records to one of the client computing devices 112 for rendering and display on a user interface (e.g., on the document viewer page 400). In response, the provider computing system 104 may receive requests to generate portable data records, and the requests may include the values to populate the portable data records.

Once the provider computing system 104 has generated the portable data records, the method 200 proceeds to step 216 at which the provider computing system 104 generates a portable file including each of the portable data records and a manifest file. In some embodiments, the portable file may be a compressed file (e.g., a zip file, a TAR file, etc.) configured to store the data in a compressed format.

In some embodiments, at step 216, the provider computing system 104 may generate a file including the data records of each of the three objects of the portable data schema in a specific file format (e.g., a CSV file, an Excel file, etc.). Likewise, in some embodiments, at step 216, the provider computing system 104 may generate a manifest or mapping file that maps the data records, according to their preexisting relationships, in the CSV files. For instance, the manifest file may include values corresponding to the rows of one or more of the CSV files and a mapping between the different rows.

In some embodiments, at step 216, the provider computing system 104 may generate a validation checksum or value. For instance, the provider computing system 104 may generate an MD5 checksum based on the data included in the portable file. Checksums function as digital fingerprints, where algorithms like MD5, SHA, or CRC process data to generate a fixed-size value representing that data's integrity; this checksum is then used for verification by recalculating it on the received or stored data and comparing it to the original, with a match indicating data integrity and a mismatch signaling alteration, primarily used for detecting accidental changes in file downloads, data transmission, storage, and software integrity.

Once the provider computing system 104 has generated the portable file, the method 200 proceeds to step 220 at which the provider computing system 104 outputs the portable file. In some embodiments, the provider computing system 104 may output the portable file to one of the client computing devices 112.

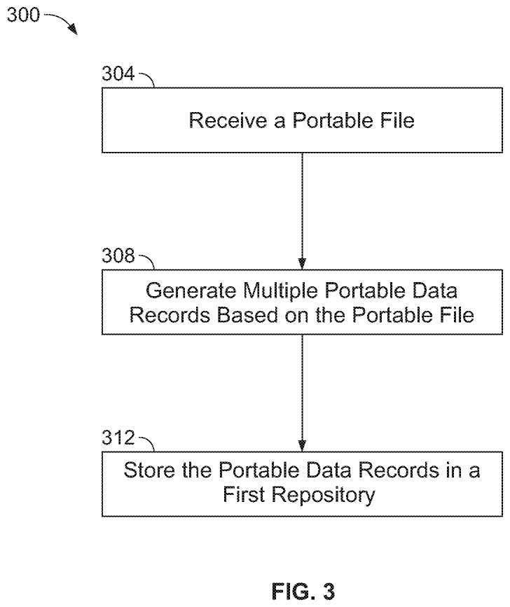

Referring now to FIG. 3, a method 300 of generating portable data records based on a portable file is shown, according to an example embodiment. While different overall, it should be understood that any steps or discussion of the method 300 may be applied or included within the methods 200, 400, 500, and 600, and vice versa, and that such combinations are included within the scope of the present disclosure. For example, the provider computing system 104 may perform the method 200 to generate a portable file and then perform the method 300 to generate portable data records based on the portable file. Method 300 can be carried out by the system of FIG. 1. In another example, the provider computing system 104 may perform the method 400, the method 500, the method 200, and then the method 300. More particularly, the method 300 can be carried out by processing circuit 128 of the provider computing system 104.

Method 300 commences at step 304 at which the provider computing system 104 receives a portable file. The portable file may be similar/the same as the portable file of the method 200 and include multiple files including portable data records, a manifest file, and a validation value. In some embodiments, at or after step 304, the provider computing system 104 may validate the portable file based on the validation value (e.g., the checksum) included therein. For instance, the provider computing system 104 may generate a second checksum value based on the portable file and compare it to the first checksum value. If the values match, the provider computing system 104 may proceed to strep 308. If not, the provider computing system 104 may generate a notification to the client computing device 112 indicating the portable file is corrupted.

Once the provider computing system 104 has received the portable file, the method 300 proceeds to step 308 at which the provider computing system 104 generates multiple portable data records based on the portable file. For instance, the provider computing system 104 may extract the portable data records of the files included in the portable file. Likewise, once the values are extracted, the provider computing system 104 may link or relate the specific data records based on the manifest file. For instance, as described herein, the manifest file may define the relationships between portable data records (e.g., child record of, parent record, related record, etc.). Accordingly, to fully generate the portable data records, the provider computing system 104 may extract the values for each portable record, generate a portable record including the value(s), and then link the portable data records according to the manifest file.

Once the provider computing system 104 has generated the portable data records, the method 300 proceeds to step 312 at which the provider computing system 104 stores the portable data records in a first repository (e.g., the portable data record repository 133).

In some embodiments, the portable file may include changes to one or more portable data records already existing in the portable data record repository 133. In this regard, instead of replacing every data record of the portable data record schema, the portable file may include one or more changes or new data records that are to replace existing data records of the portable data schema.

Referring now to FIG. 4, a method 400 of generating a test specification data schema is shown, according to an example embodiment. Method 400 can be carried out by the system of FIG. 1. More particularly, the method 400 can be carried out by the processing circuit 128 of the provider computing system 104 and through communication with the partner computing systems 108 and the client computing devices 112.

Method 400 commences at step 404 at which the provider computing system 104 receives a source file including at least one linguistic section (e.g., sections, such as paragraphs, including multiple words and terms). For example, a source file may be an email including a subject line (a first linguistic section), a body message (a second linguistic section), a sender email address, a recipient email address, and one or more attachments (possibly including additional linguistic sections). In another example, the source file may be at least one of a PDF file, a text file, a word processing file, a spreadsheet file (e.g., an excel file), a Comma-Separated Value (CSV) file, and the like. In some embodiments, the source file may be unstructured data (e.g., a PDF file).

The linguistic section(s) may include words and terms defining a test specification. In one example, the source file may be a PDF document of a test specification, and the linguistic sections may be each section or sub portion of the test specification. In another example, the provider computing system 104 may receive an email including a PDF attachment. The PDF attachment may be the test specification file including the specific events that comprise the test and the definitions thereof, and the like. In some embodiments, the linguistic section may include text data. In other embodiments, the linguistic section may not include text data and may be an image or PDF file.

If the linguistic section(s) of the source file do not include text data, the provider computing system 104 may proceed to optional step 408 at which the provider computing system generates text data based on the source file (e.g., based on the linguistic sections of the source file). For instance, the provider computing system 104 may perform Optical character recognition (OCR), Regex, natural language processing (NLP), or other text recognition methods on the linguistic sections of the source file. In one example, the provider computing system 104 may use OCR to generate text data based on the linguistic sections and then add the text data to the source file. In another example, the provider computing system 104 may use OCR to generate text data based on the linguistic sections and then generate a text file including the text data therein.

In some embodiments, to generate the text data, the provider computing system 104 may generate a request including the source file, an API key, and a text query (e.g., a prompt). The provider computing system 104 may then output the request to one of the partner computing systems 108. In response, the partner computing system 108 may output a response file, to the provider computing system, including the text data of the linguistic section(s). In some embodiments, the provider computing system 104 may generate multiple requests, each including the source file but including different API keys. Each request may then be output to different partner computing systems 108, and the provider computing system 104 may receive multiple response files. In some embodiments, only text data that matches between the response files may be utilized at step 412.

In some embodiments, the text data may be generated in a first language. Then, at or after step 408, the provider computing system 104 may translate the text data from the first language to a second language. For instance, the source file may include a linguistic section which is in French. Accordingly, the text data may be generated in French and then translated to English.

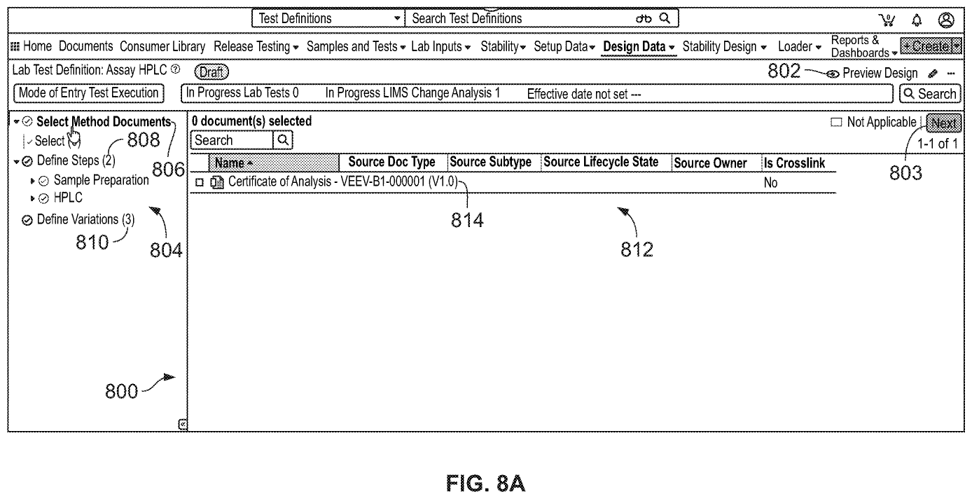

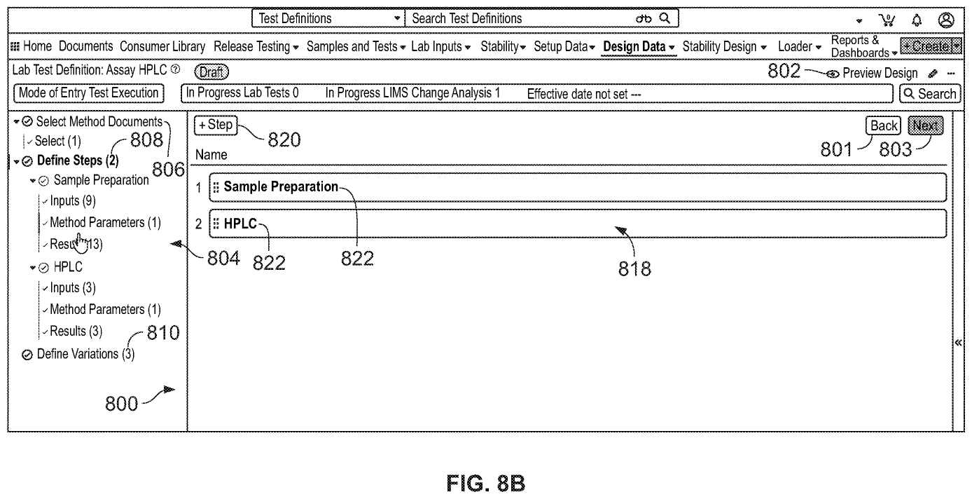

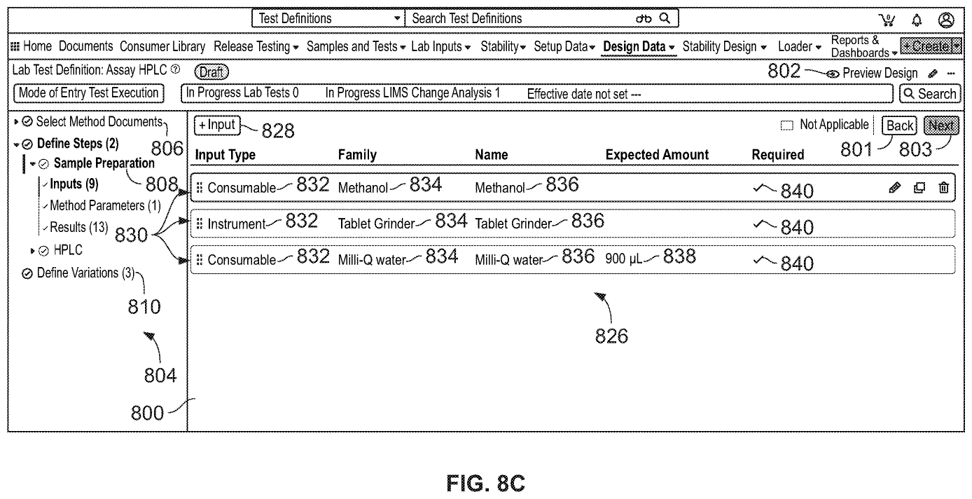

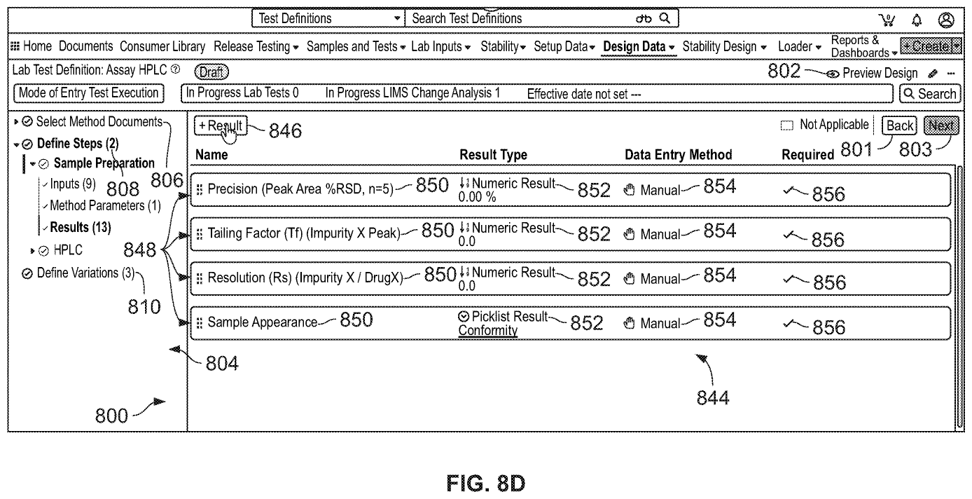

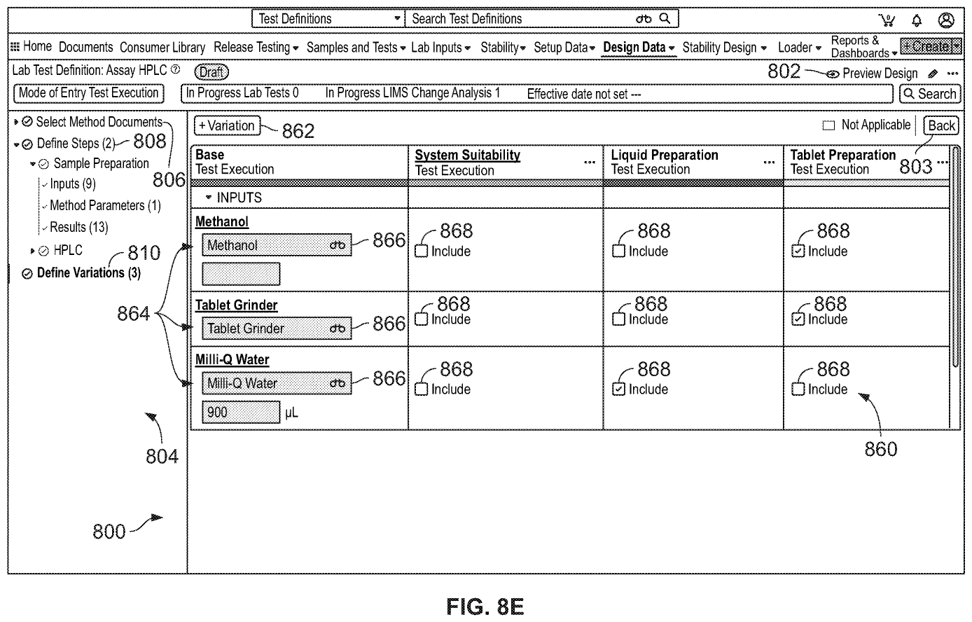

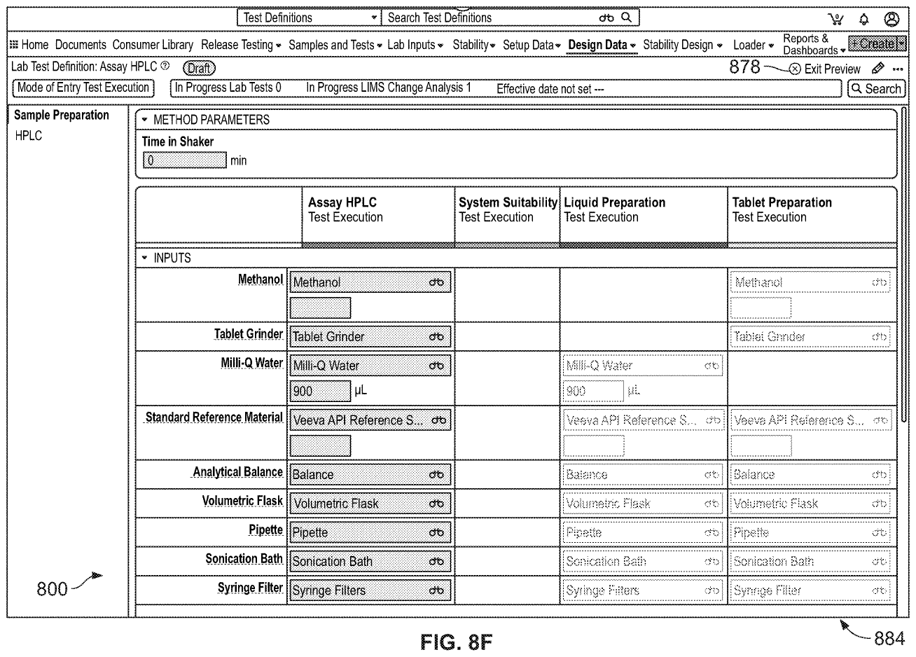

If at step 404, the source file includes text data, the method 400 may proceed to step 412. Likewise, once the provider computing system 104 has generated the text data at step 408, the method 400 may proceed to step 412. At step 412, the provider computing system 104 may determine at least one event based on the text data of the source file. As described herein and shown in the test builder page 800 of FIGS. 8A-8F, each “event” or “event data schema” may correspond to or include data of a procedural step or a group of procedural steps in a testing specification. For instance, as shown in FIG. 8B, a test specification could have two main events or steps for testing a medical product: sample preparation and High-performance liquid chromatography (HPLC). Then, each event can include multiple inputs, parameters, and results. In this regard, at step 412, the provider computing system 104 may parse and analyze the text data for events included therein. In some embodiments, at step 412, the provider computing system 104 may determine one or more events and alternative events or variations for each event based on the text data.

In some embodiments, determining the events may comprise two steps or portions: 1) determining, by the provider computing system 104, events based on the text data and a parent event schema, and 2) receiving events, via a user interface, from one of the client computing devices 112. In some embodiments, the events may be received via selection of text data on the user interface. In some embodiments, each step may be performed separately. For instance, the provider computing system 104 may determine events based on the text data at a first time (e.g., at step 412), and then receive one or more events from the client computing device 112 thereafter.

In this regard, the provider computing system 104 may determine the events by parsing the text data for words and terms that correspond to each of the fields and values of the inputs, parameters, and results. In one example, the provider computing system 104 may parse the text data for a word or term corresponding to specific input types (e.g., consumable, reusable etc.). In some embodiments, the provider computing system 104 may search or parse the text data for terms that define a specific number of things (e.g., “Event 1” “Event 2,” etc.).

In some embodiments, the provider computing system 104 may utilize a large language model (LLM) (e.g., Google Gemini®, OpenAI Chat GPT®, an internal LLM, etc.) to search the text data for potential events and sub-components thereof. For instance, the provider computing system 104 may generate a request including the text data, an API key, and a specific text query or prompt (e.g., “The attached text corresponds to a testing specification, which defines multiple test events or steps. Determine each testing step included therein. Likewise, for each testing step determine each input, each parameter, and each result. Deliver the results in the following format . . . ”). The request may then be output to a partner computing system 108 which may analyze the text data. In response to outputting the request, the provider computing system 104 may receive a response file identifying or including the event including the inputs, the parameters, and the results. In some embodiments, the request may identify the location of each in the text data. In some embodiments, the request may be generated to include data of the repositories (e.g., product records of a product repository (not shown, test data schemas of the test data repository 135, etc.).

In some embodiments, to determine the events at step 412, the provider computing system 104 may generate multiple requests, each including the text data and the query, but including different API keys. Each request may then be output to a different partner computing system 108, and the provider computing system 104 may receive multiple response files. In some embodiments, the provider computing system 104 may only proceed with events which are identified by each of the response files. For instance, the provider computing system 104 may receive three response files, with two of the response files identifying three events (a first, second and third event), and a third identifying four events (the first, the second, the third, and a fourth event). In response, the provider computing system 104 may verify the first event, the second, event, and the third event, but not the fourth event. This process may be repeated for each input, parameter, and result of each of the events such that only data which is unanimous among response files is utilized. In other embodiments, the provider computing system 104 may receive a threshold percentage, such that if a specific percentage of partner computing systems 108 include the data (e.g., the event, the input, etc.) the provider computing system 104 verifies and utilizes the data.

Once the provider computing system 104 has determined one or more events based on the text data, the provider computing system 104 may provide the source file, the text data, and the events to one of the client computing devices 112 for rendering and display on a user interface. The source file and text data may be displayed in a document viewer (not shown) of the test builder page 800 and the events may be displayed in a test panel 804. The user of the client computing device 112 may review the events of the test panel 804, verify each is correct, and identify additional events of the test specification therein. For instance, the user may add additional events and edit existing events, which may then be provided to the provider computing system 104, as described further herein.

In some embodiments, after determining each event, the provider computing system 104 may generate an event data schema for each. The event data schema may define the specific inputs, parameters, and results or outcomes of the specific event and include fields that define specific portions of the event (e.g., name, created date/time, etc.). As described further herein, the event data schema may then be used to generate an event data record during a testing procedure.

In some embodiments, at step 412, the provider computing system 104 may further determine one or more variations or departures from the event results. The variations may define specific instances within each event, in which values can be outside of the exact result parameters but still fall within the test specification. Accordingly, at step 412, the provider computing system 104 may determine variations in the same manner described as determining the events.

Once the provider computing system 104 has determined each event, the method 400 proceeds to step 416 at which the provider computing system 104 determines each event is complete. In some embodiments, to determine if each event is complete, the provider computing system 104 may verify each event or event data schema includes at least one input, at least one parameter, and at least one result or outcome. If each event is complete, the provider computing system 104 may proceed to step 420. Ins some embodiments, if an event is complete the provider computing system 104 indicate as such on the user interface (e.g., on the events panel 804) as will be described further herein. If the provider computing system 104 determines at least one event is incomplete, the provider computing system 104 may generate and output a notification to one of the client computing devices 112. Then, after receiving the additional portions of the event from the client computing device 112, the provider computing system 104 may proceed to step 420.

By utilizing multiple LLMS, data sources, and a builder user interface, the present systems and methods may provide for touchless intake of test specification, which is a large complex document. In this regard, the present systems and methods better bridge the gap between human-authored requirements and machine-executable data models. This orchestrated approach eliminates the bottleneck of manual data entry, proactively resolves implicit conflicts and ambiguities across disparate data sources, and provides for traceability from the original document to the generated schemas. Ultimately, this enables organizations to scale their testing and validation architectures dynamically, mitigate human error, and dramatically accelerate the time-to-deployment for complex technical systems.

At step 420, the provider computing system 104 generates a test specification data schema based on the events determined at step 416. For instance, the provider computing system 104 may generate a test specification data schema that includes and defines each of events. In the example shown in FIG. 8B, the provider computing system 104 may generate a test specification data schema that includes a first event (e.g., sample preparation) and a second event (HPLC). The first event may include 9 inputs, 1 parameter, and 13 results. The second event may include 3 inputs, 1 parameter, and 3 results. Likewise, the test specification data schema may include the variations determined at or after step 412. In some embodiments, the provider computing system 104 may generate the test specification data schema including reference or link the generated event data schemas described with reference to step 412.

Once the provider computing system 104 has generated the test specification data schema, the method 400 proceeds to step 424 at which the provider computing system 104 stores the test definition data schema in the test data repository 135. In this regard, with reference to method 500, the test data repository 135 may include multiple test specification data schemas which each define a separate test for use in testing and performing quality control of a product.

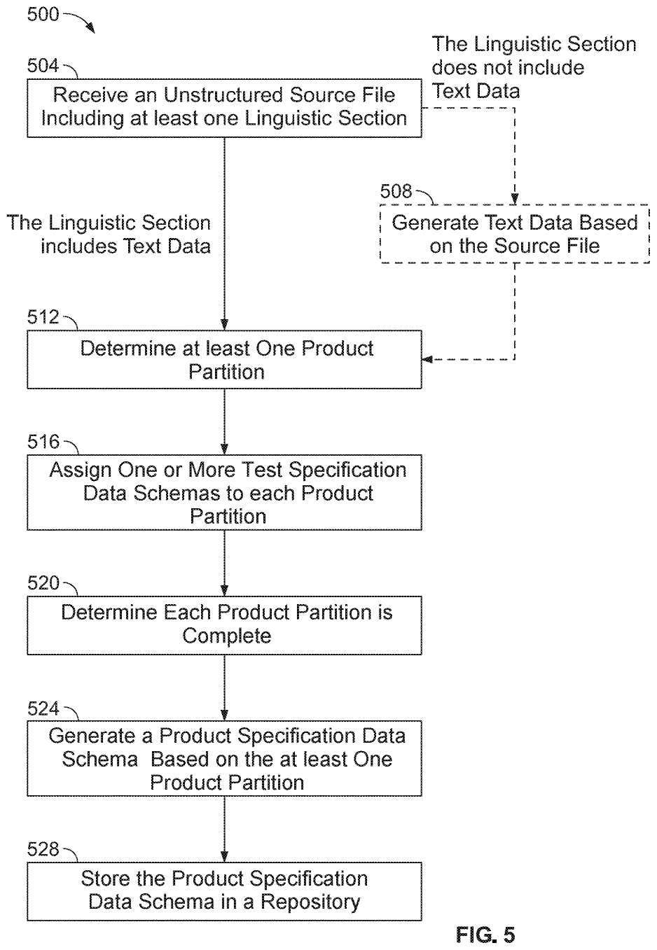

Referring now to FIG. 5, a method 500 of generating a product specification data schema is shown, according to an example embodiment. Method 500 can be carried out by the system of FIG. 1. More particularly, the method 500 can be carried out by the processing circuit 128 of the provider computing system 104 and through communication with the partner computing systems 108 and the client computing devices 112.

Method 500 commences at step 504 at which the provider computing system 104 receives a source file including at least one linguistic section (e.g., sections, such as paragraphs, including multiple words and terms). For example, a source file may be an email including a subject line (a first linguistic section), a body message (a second linguistic section), a sender email address, a recipient email address, and one or more attachments (possibly including additional linguistic sections). In another example, the source file may be at least one of a PDF file, a text file, a word processing file, a spreadsheet file (e.g., an excel file), a Comma-Separated Value (CSV) file, and the like. In some embodiments, the source file may be unstructured data (e.g., a PDF file).

The linguistic section(s) may include words and terms defining a product specification. In one example, the source file may be a PDF document of a product specification and the linguistic sections may be each section or sub portion of the product specification. In another example, the provider computing system 104 may receive an email including a PDF attachment. The PDF attachment may be the product specification file including the sub-partitions of the product and the tests to be applied to them. In some embodiments, the linguistic section may include text data. In other embodiments, the linguistic section may not include text data and may be an image or PDF file.

If the linguistic section(s) of the source file do not include text data, the provider computing system 104 may proceed to optional step 508 at which the provider computing system generates text data based on the source file (e.g., based on the linguistic sections of the source file). For instance, the provider computing system 104 may perform Optical character recognition (OCR), Regex, natural language processing (NLP), or other text recognition methods on the linguistic sections of the source file. In one example, the provider computing system 104 may use OCR to generate text data based on the linguistic sections and then add the text data to the source file. In another example, the provider computing system 104 may use OCR to generate text data based on the linguistic sections and then generate a text file including the text data therein.

In some embodiments, to generate the text data, the provider computing system 104 may generate a request including the source file, an API key, and a text query (e.g., a prompt). The provider computing system 104 may then output the request to one of the partner computing systems 108. In response, the partner computing system 108 may output a response file, to the provider computing system, including the text data of the linguistic section(s). In some embodiments, the provider computing system 104 may generate multiple requests, each including the source file but including different API keys. Each request may then be output to different partner computing systems 108, and the provider computing system 104 may receive multiple response files. In some embodiments, only text data that matches between the response files may be utilized at step 512.

In some embodiments, the text data may be generated in a first language. Then, at or after step 508, the provider computing system 104 may translate the text data from the first language to a second language. For instance, the source file may include a linguistic section which is in French. Accordingly, the text data may be generated in French and then translated to English.

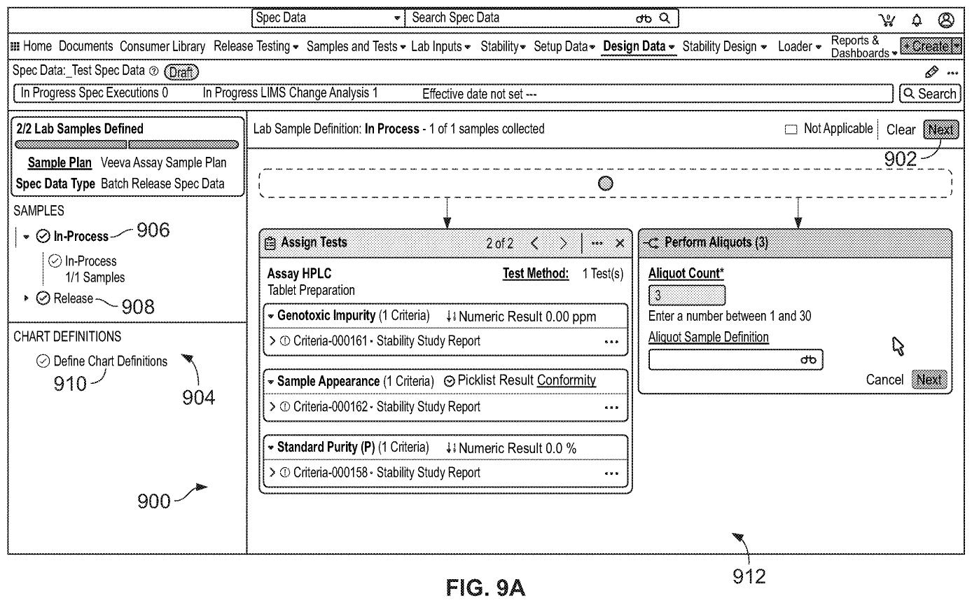

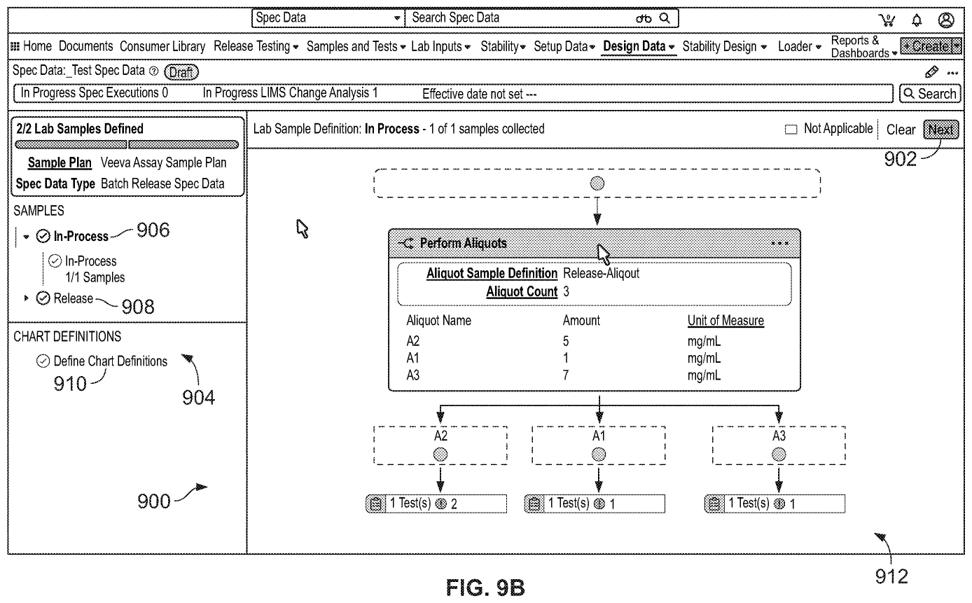

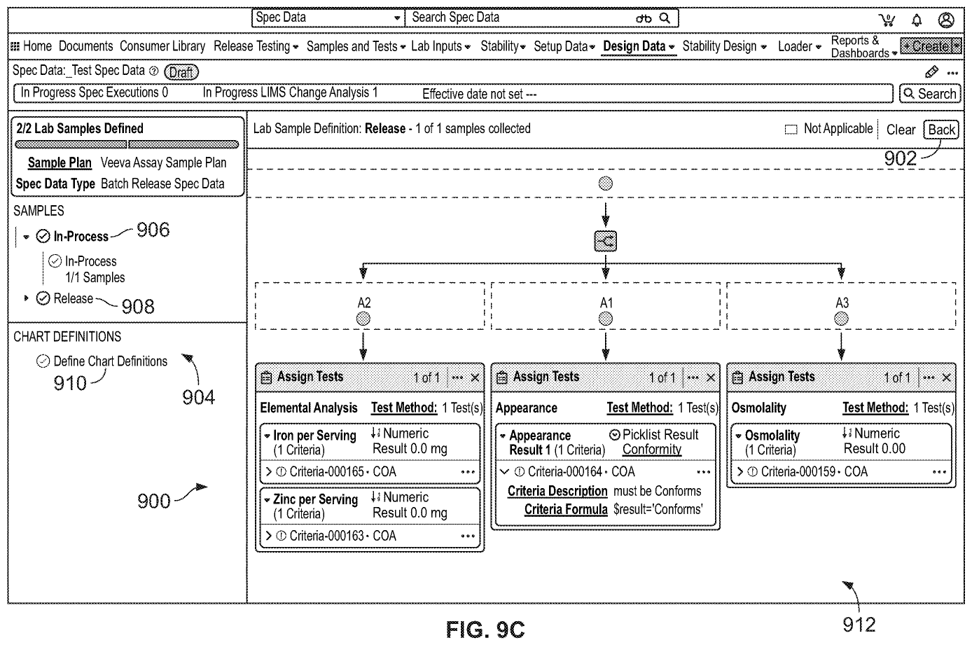

If at step 504, the source file includes text data, the method 500 may proceed to step 512. Likewise, once the provider computing system 104 has generated the text data at step 508, the method 500 may proceed to step 512. At step 512, the provider computing system 104 may determine product partition based on the text data. As described herein and shown in the product specification builder page 900 of FIGS. 9A-9C, each “product partition” or “product partition data schema” may correspond to or include data of a partition, subdivision, or aliquot of a product and tests which are to be applied to the aliquot. For instance, as shown in FIG. 9B, a product specification may define three aliquots which are to be performed (including the name of the aliquot, the amount in the aliquot, and the like) and one or more tests which are to be applied to each aliquot. In this regard, at step 512, the provider computing system 104 may parse and analyze the text data for product partitions included therein and tests which are to be applied to the product partitions. In some embodiments, at step 512, the provider computing system 104 may determine one or more chart definitions which apply to the product partitions and/or tests.

In some embodiments, determining the product partitions may comprise two steps or portions: 1) determining, by the provider computing system 104, product partitions, and 2) receiving product partitions, via a user interface, from one of the client computing devices 112. In some embodiments, the product partitions may be received via a selection of text data on the user interface. In some embodiments, each step may be performed separately. For instance, the provider computing system 104 may determine product partitions based on the text data at a first time (e.g., at step 412), and then receive one or more product partitions from the client computing device 112 thereafter.

In this regard, the provider computing system 104 may determine the product partitions by parsing the text data for words and terms that correspond to each of the fields and values of the product partitions (the number of product partitions, the name of the product partitions, the size of the product partitions, the units of measurement of the product partitions, etc.). In one example, the provider computing system 104 may parse the text data for a word or term corresponding to specific units of measurement (e.g., milliliter or mL, liter or L, gallon, grams or g, milligrams or mg, etc.). In some embodiments, the provider computing system 104 may search or parse the text data for terms that define aliquots and/or a specific number of things (e.g., “Aliquot 1,” “Aliquot 2,” “Division 1” “Division 2,” etc.). In another example, the provider computing system 104 may search for product names (e.g., Tylenol, drug x) or test names. For instance, the provider computing system 104 may cross-reference one or more repositories and the data included therein (the test data repository 135, a product repository (not shown), etc.) against the text data. If a match is determined, the provider computing system 104 may analyze the corresponding text for a product partition.

In some embodiments, the provider computing system 104 may utilize a large language model (LLM) (e.g., Google Gemini®, OpenAI Chat GPT®, an internal LLM, etc.) to search the text data for product partitions and tests. For instance, the provider computing system 104 may generate a request including the text data, an API key, and a specific text query or prompt (e.g., “The attached text corresponds to a testing specification, which defines multiple test events or steps. Determine each testing step included therein. Likewise, for each testing step, determine each input, each parameter, and each result. Deliver the results in the following format . . . ”). The request may then be output to a partner computing system 108 which may analyze the text data. In response to outputting the request, the provider computing system 104 may receive a response file identifying or including the product partitions and/or assigned tests. In some embodiments, the request may identify the location of each in the text data. In some embodiments, the request may be generated to include data of the repositories of the provider computing system 104 (e.g., test data schemas of the test data repository 135, product records of the product repository, etc.).

In some embodiments, to determine the product partitions at step 512, the provider computing system 104 may generate multiple requests, each including the text data and the query, but including different API keys. Each request may then be output to a different partner computing system 108, and the provider computing system 104 may receive multiple response files. In some embodiments, the provider computing system 104 may only proceed with events which are identified by each of the response files. For instance, the provider computing system 104 may receive three response files, with two of the response files identifying three partitions (a first, second and a third partition), and a third identifying four partitions (the first, the second, the third, and a fourth partition). In response, the provider computing system 104 may verify the first event, the second, event, and the third event, but not the fourth product partition. This process may be repeated for each amount, unit of measure, name, and the like of each of the product partitions such that only data which is unanimous among response files is utilized. In other embodiments, the provider computing system 104 may receive a threshold percentage, such that if a specific percentage of partner computing systems 108 include the data (e.g., the product partition, the test, etc.) the provider computing system 104 verifies and utilizes the data.

In some embodiments, after determining each partition, the provider computing system 104 may generate a product partition schema for each. The product partition schema may define the specific size of the product partition, the name of the product partition, the units of the product partition and the like. As described further herein, the product partition schema may then be used to generate a product partition data record during a testing procedure.

Once the provider computing system 104 has determined each product partition, the method 500 proceeds to step 516 at which the provider computing system 104 assigns one or more test specification data schemas to each product partition. As described herein, the product specification may define a specific procedure for performing quality assurance on a product. Accordingly, the product specification may define product partitions or aliquots into which the product is to be divided and specific tests which are to be applied to the product partitions (see FIG. 9C). In this regard, after determining the product partitions, the provider computing system 104 may determine the test definitions which are to be applied to the product partition and assign it to the product partition. In some embodiments, the product partition data schema may include a link to the test definition data record. In some embodiments, the product partition data schema includes code which creates a test definition data record based on the assigned test definition data schema, when the product partition data record is created.

In some embodiments, to assign one or more test specifications to each product partition, the provider computing system 104 may parse the text data for text corresponding to a test data schema of the test data repository 135 (e.g., “HLCP”). In other embodiments, the provider computing system 104 may determine the assigned test data schemas through the requests sent at step 512. For instance, the request may include a text query asking the partner computing system 108 to find the product partitions and assigned test specifications for each product partition. In response, the response file may identify the specific product partitions and assigned test specifications. Accordingly, the provider computing system 104 may assign the test specifications at step 516 based on the response file.

Once the provider computing system 104 has determined one or more partitions based on the text data and assigned the test specifications to the product partitions, the provider computing system 104 may provide the source file, the text data, the product partitions, and the test specifications to one of the client computing devices 112 for rendering and display on a user interface. The source file and text data may be displayed in a document viewer (not shown) of the spec builder page 900 and the partitions may be displayed in an samples panel 904. The user of the client computing device 112 may review the partitions and assigned tests, verify each is correct, and identify additional partitions or assigned tests of the product specification therein. For instance, the user may add additional partitions, edit existing partitions, and assign tests, which may then be provided to the provider computing system 104, as described further herein.

Once the provider computing system 104 has assigned the tests, the method 500 proceeds to step 520 at which the provider computing system 104 determines each product partition is complete. In some embodiments, to determine if each product partition is complete, the provider computing system 104 may verify each product partition or product partition schema includes at least one amount, unit of measure, name, and an assigned test. If each product partition is complete, the provider computing system 104 may proceed to step 524. Ins some embodiments, if an event is complete the provider computing system 104 indicate as such on the user interface (e.g., on the samples panel 904) as will be described further herein. If the provider computing system 104 determines at least one product partition t is incomplete, the provider computing system 104 may generate and output a notification to one of the client computing devices 112. Then, after receiving the additional portions of the product partition t from the client computing device 112, the provider computing system 104 may proceed to step 524.

By utilizing multiple LLMS, data sources, and xxx, the present systems and methods may provide for touchless intake of test specification.

At step 524, the provider computing system 104 generates a product specification data schema based on the product partition determined at step 512. For instance, the provider computing system 104 may generate a product specification data schema that includes and defines each of product partitions and their assigned events. In the example shown in FIG. 9B, the provider computing system 104 may generate a product specification data schema that includes a first product partition (A1), a second product partition (A2), and a third product partition (A3). Each product partition may include an assigned test. In some embodiments, the provider computing system 104 may generate the product specification data schema including reference or link the generated product partition data schemas described with reference to step 512.

Once the provider computing system 104 has generated the product specification data schema, the method 500 proceeds to step 528 at which the provider computing system 104 stores the product specification data schema in the product data repository 134. In this regard, with reference to method 500, the test product data repository 134 may include multiple product specification data schemas which each defining a separate procedure for performing quality assurance on a product.

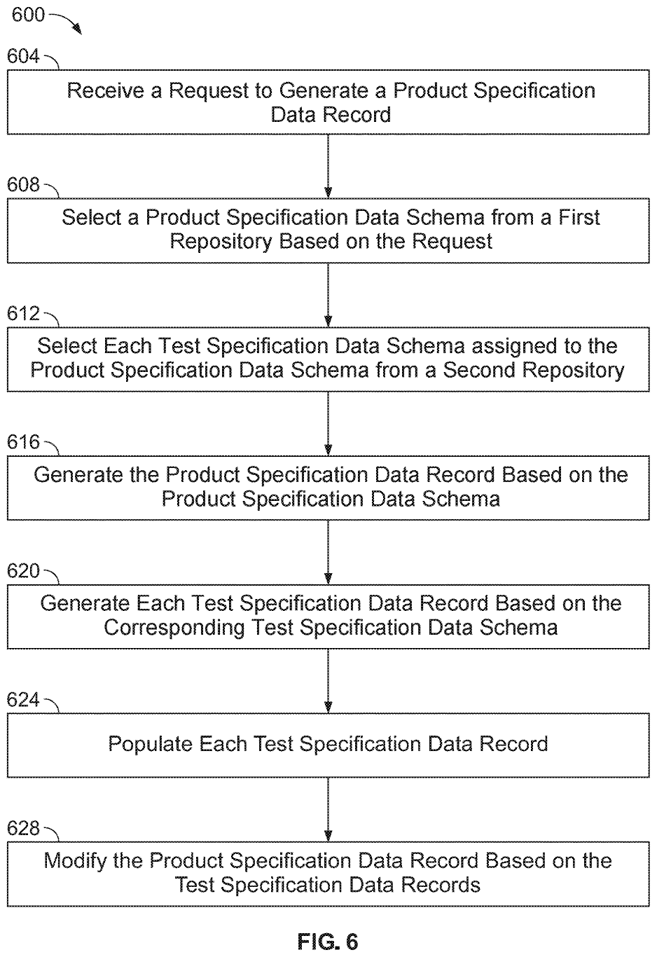

Referring now to FIG. 6, a method 600 of instantiating multiple test specification data records based on a product specification data record is shown, according to an example embodiment. Method 600 can be carried out by the system of FIG. 1. More particularly, the method 600 can be carried out by the processing circuit 128 of the provider computing system 104 and through communication with the partner computing systems 108 and the client computing devices 112.

Method 600 commences at step 604 at which the provider computing system 104 receives a request to generate a product specification data record. In some embodiments, the request may be received from one of the client computing devices 112 and identify the specific product specification. In other embodiments, the provider computing system 104 may receive a product specification rule, which defines a specific rule criterion or interval at which product specification data records are to be generated and assigned to a user account (e.g., monthly, quarterly, yearly, etc.). Then, based on the rule, the provider computing system 104 may proceed to step 608.

Once the provider computing system 104 has received the request, the method 600 proceeds to step 608 at which the provider computing system 104 selects a product specification data schema from the product data repository 134. For instance, as described herein, the request may identify a specific product or product specification, and the provider computing system may select the product specification data schema from the product data repository 134 based on the request. In other embodiments, the rule may identify a specific product or product specification, and the provider computing system may select the product specification data schema from the product data repository 134 based on the rule.

Once the provider computing system 104 has selected the product specification data schema from the product data repository 134, the method 600 proceeds to step 612 at which the provider computing system 104 selects each test specification data schema assigned to the product specification data schema from the test data repository 135. As described herein with reference to the method 500, multiple test definitions may be assigned to the product specification data schema (i.e., to the product partitions thereof). Accordingly, at step 612, the provider computing system 104 may determine each test definition or test assigned to the product partition data schema and select the test definition data schemas from the test data repository 135 based on their assignment/being included in the product specification data schema.

Once the provider computing system 104 has selected each test specification data schema, the method 600 proceeds to step 616 at which the provider computing system 104 generates or instantiates the product specification data record based on the product specification data schema. The product specification data record may be instantiated based on the product specification data schema such that it includes a product partition data record for each product partition of the product specification data schema. For instance, the product specification data schema may include three product partitions (see FIG. 9B), and the instantiated product specification data record may include three product partition data records. Likewise, the product specification data record may include metadata (e.g., date created, created by user account, record number, and the like).

In some embodiments, the product specification data record may be assigned to a specific user account for completion. In some embodiments, the product specification data record may be assigned to a specific user account based on the rule described herein. For instance, the rule may identify a specific user account, and the provider computing system 104 may assign or link the product specification data record to the specific user account.

Once the provider computing system 104 has instantiated or generated the product specification data record, the method 600 may proceed to step 620 at which the provider computing system 104 generates or instantiates multiple test specification data records. For instance, the provider computing system 104 may instantiate a test specification data record for each test specification data schema selected at step 612. Each specification data record may be instantiated based on the corresponding test specification data schema such that it includes an event data record for each event of the test specification data schema. For instance, the test specification data schema may include two events (see FIG. 8B), and the instantiated test specification data record may include two event data records. Likewise, the test specification data record may include metadata (e.g., date created, created by user account, record number, and the like).

In some embodiments, the test specification data record and/or the events thereof may be assigned to a specific user account for completion. In some embodiments, the test specification data record may be assigned to a specific user account based on the rule described herein. For instance, the rule may identify a specific user account, and the provider computing system 104 may assign or link the test specification data record to the specific user account.

Once the provider computing system 104 has generated each test specification data record, the method 600 proceeds to 624 at which the provider computing system 104 populates each test specification data record. For instance, as described herein, the provider computing system 104 may populate and process each event data record of each test specification data record. In one example, the provider computing system 104 may output at least a portion of the test specification data record to one of the user computing devices 112 for display on a user interface. Then, the provider computing system 104 may receive test results in the result fields of the event records. In some embodiments, the provider computing system 104 may then compare the results against expected values and approve or reject the test data record.

Once the provider computing system 104 has populated one or more of the test specification data records, the method 600 proceeds to step 628 at which the provider computing system 104 modifies the product specification data record. For instance, the provider computing system 104 may determine that each test definition data record came back within the correct parameters and is approved. Then, in response, the provider computing system 104 may approve or verify the product specification data record. In another example, the product specification data record may include a lifecycle state field, and the provider computing system 104 may move the lifecycle state field to an approved field based on the test specification data records each coming back within the correct parameters.

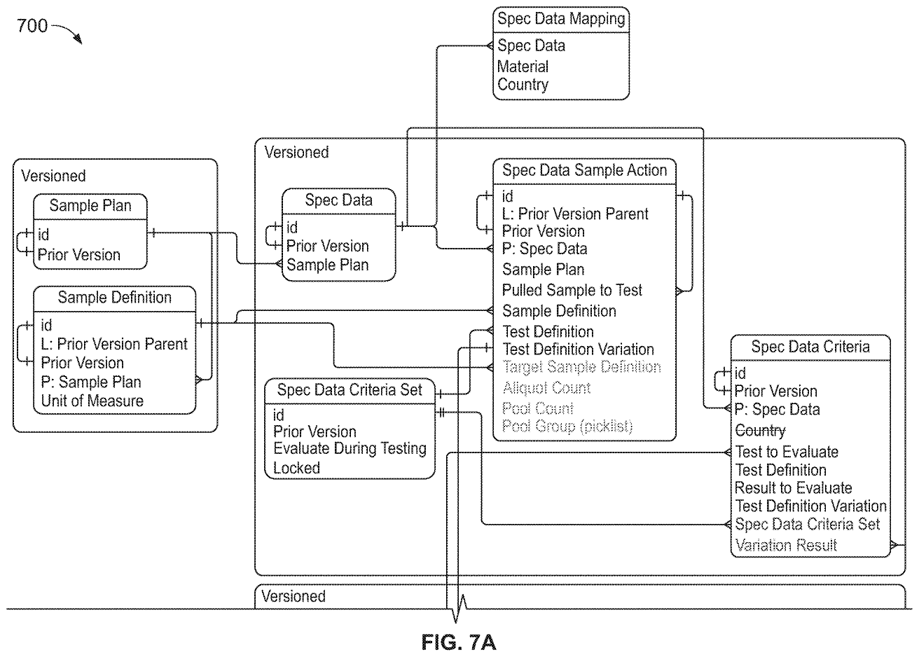

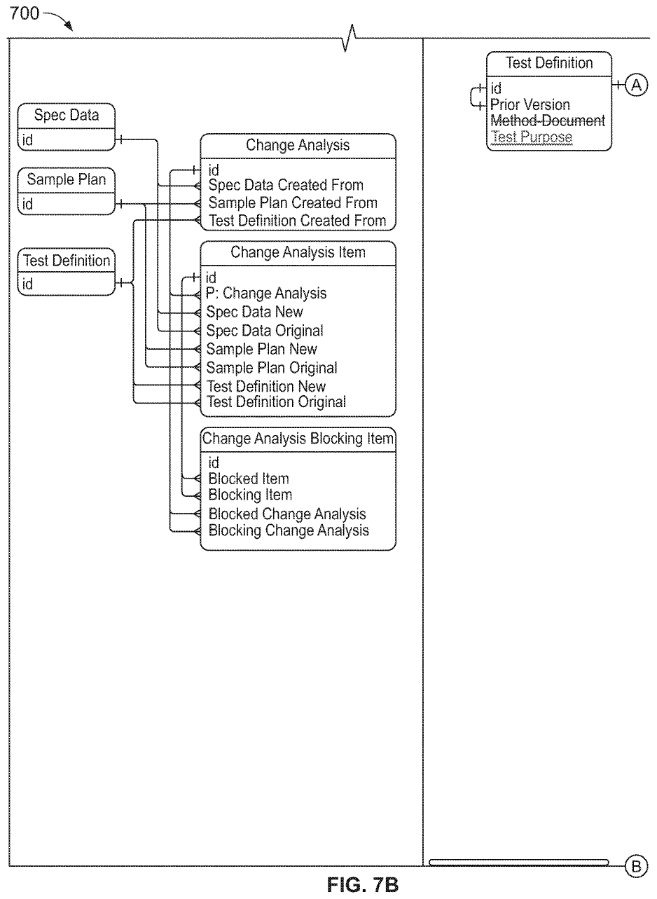

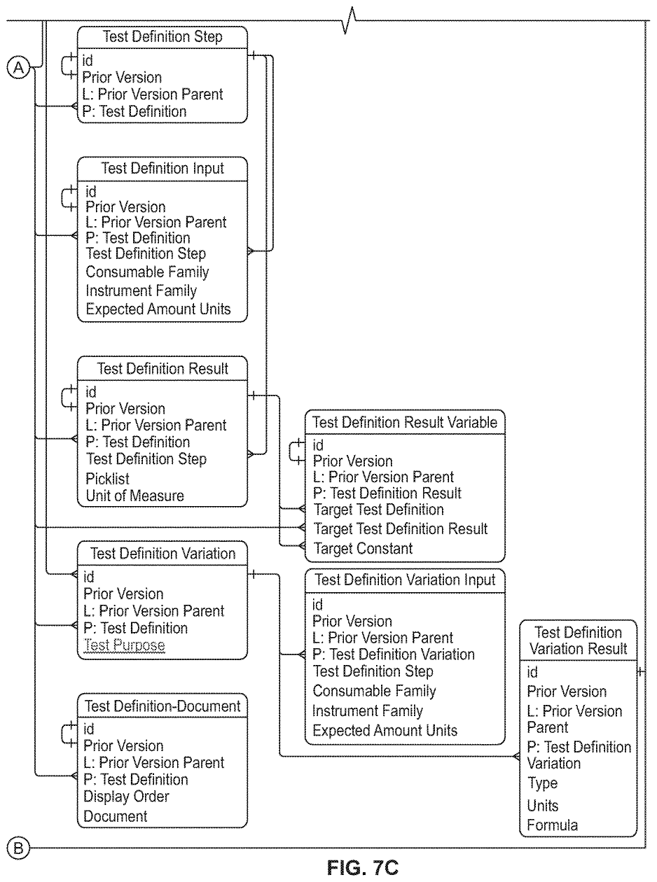

Referring now to FIGS. 7A-7B, a FIGS. a portable data schema 700 is shown, according to an example embodiment. As shown, the portable data schema 700 includes the specification data unit data object, a sample plan data object, and the test definition unit data object.

Referring now to FIGS. 8A-9C, user interfaces shown and displayed to the user of the one or more client computing devices 112 during the methods 200-600 are shown, according to example embodiments. As described herein, the user interfaces of FIGS. 8A-9C may be one or more of web interfaces generated by the provider computing system 104 and rendered by each of the client computing devices 112 as part of a web application or graphical user interfaces downloaded and generated by each of the client computing devices 112 as part of a software application (e.g., a mobile application, etc.). Further, the user interfaces shown on FIGS. 8A-9C allow for communication between the user and the provider computing system 104 via the respective client computing device 112 (specifically via the I/O circuit 180, respectfully). Through interaction with the various user interfaces, the user may provide user input, feedback, and other data requested by the provider computing system 104. In this regard, it should be understood that each interaction described herein by the user with the user interfaces of FIGS. 8A-9C may be provided to one or more of the client computing devices 112 and then transmitted to the provider computing system 104 and that each action described herein as occurring to the respective client computing device 112 (e.g., navigating to a certain page, generating a popup, etc.) may be performed by the provider computing system 104.

Referring now to FIGS. 8A-8F, the test builder page 800 which can be displayed on a display the I/O circuit 180 of the client computing device 112, is shown. In general, the test builder page 800 provides the user an interface to view, modify, and generate a test specification data schema from a specific source file received by the provider computing system 104. As shown, the test builder page 800 includes a preview design button 802, a back button 801, a next button 803, the test panel 804, a document selection section 812, an event section 818, an input section 826, a results section 844, a variations section 860, and a design preview section 884. In some embodiments, the test builder page 800 further includes a document viewer section (not shown) and/or a parameters section (not shown). In this regard, it should be understood that each of the sections, fields, or buttons of the test builder page 800 may include data of the test specification data schema and data records described herein.

The back button 802 and the next button 803 may be buttons that provide for navigation to the different sections of the test builder page 800. For instance, the user, via the client computing device 112 may select a document in the document selection section 812 and then select the next button 803 to proceed to the event section 818.

The preview design button 802 may be a selectable button that navigates the user to the design preview section 884. The preview design section 884 may provide for a simple to view overview of the test specification design (e.g., all of the different events and variations of the test specification). Likewise, the design preview section 884 may include an exit button 878 which navigates the user of the client computing device 112 from the design preview section 884 to the section the user was on before clicking the preview design button 802 (e.g., the document selection section 812, the event section 818, etc.).

The test panel 804 may provide an overview as to the status of the test specification and include a document status 806, one or more event statuses 808, and one or more variation statuses 810. Each of the statuses may provide an indication as to which is complete, in-progress or incomplete. For instance, in response to a source file being uploaded/provided to the provider computing system 104, the document status 806 may go from a first indication (e.g., a red x) to a second indication (e.g., a green check). Likewise, in response to the provider computing system 104 determining an event based on the source file, the event statuses 808 may go from the first indication (e.g., a red x) to a second indication (e.g., a green check). In another example, in response to the provider computing system 104 determining an event, with no inputs, based on the source file, the event statuses 808 may go from the first indication (e.g., a red x) to a third indication (e.g., a yellow question mark). In some embodiments, each of the statuses may be at least a first indication indicating the data is complete (e.g., the green checkmark), a second indication indicating the data is received but incomplete (e.g., the yellow question mark), and a third indication indicating no data has been received (e.g., the red x).

The document selection section 812 may provide the user an interface to upload a source file to the provider computing system 104. In this regard, the document selection section 812 may include the document name field 814 and an upload button (not shown). The upload button may be a selectable button that, when selected, opens a file navigation panel for finding and uploading a source file to the provider computing system 104 for processing (e.g., see method 400). Likewise, once uploaded, the document may appear in the document selection section 812 and include a name field 814. In some embodiments, the name field may be a selectable link that, when selected, navigates the user to the document.

The event section 818 provides the user an interface to view and modify the events of the test specification. In this regard, the event section 818 includes an add button 820 and multiple event representations 822. The add button 820 may be a selectable button that, when selected, causes the provider computing system 104 to generate a blank event representation 822, which then may be modified and updated as described herein. Likewise, the event representations 822 may each represent a specific event and include a name associated with the event 822. For instance, the provider computing system 104 may determine the source file includes three events, and, in response, the event section 818 may include three event representations 822. The input section 826, the results section 844, and the parameters section (not shown) may then provide an interface to update the inputs, parameters, and results or outcomes of the event.

For each event, the input section 826 provides the user an interface to update and manage the inputs for a specific event. Each input section 826 may be specific to an event of the test specification and may include an add button 828 and multiple input representations 830. The add button 828 may be a selectable button that, when selected, causes the provider computing system 104 to generate a blank input representation 830, which then may be modified and updated as described herein.

Each input representation 830 may represent an input for a test and include an input type field 832, an input family field 834, an input name field 836, an expected amount field 838, and a required field 840. Each of the fields 832-840 may include the data for the specific input of the input representation 830. In this regard, each of the fields 832-840 may be determined by the provider computing system 104 as a part of the methods 200-600 and be used to populate the inputs of the test data schema.

For each event, the results section 844 provides the user an interface to update and manage the results for a specific event. Each results section 844 may be specific to an event of the test specification and may include an add button 846 and multiple result representations 848. The add button 846 may be a selectable button that, when selected, causes the provider computing system 104 to generate a blank result representation 848, which then may be modified and updated as described herein.

Each result representation 848 may represent a result for a test and include a result name field 850, a result type field 852, a data entry field 854, and required field 856. Each of the fields 850-856 may include the data for the specific result of the result representation 848. In this regard, each of the fields 850-856 may be determined by the provider computing system 104 as a part of the methods 200-600 and be used to populate the results of the test data schema.

The variations section 860 may provide the user an interface to setup and manage the variations for the events of the test specification. In this regard, the variations section 860 includes an add button 862 and multiple variation representations 864. The add button 862 may be a selectable button that, when selected, causes the provider computing system 104 to generate a blank variation representation 864, which then may be modified and updated as described herein.

Each variation representation 864 may represent a variation for a result of a test and include n input field 866 and multiple include checkboxes 868.

Referring now to FIGS. 9A-9C, the specification builder page 900 which can be displayed on a display the I/O circuit 180 of the client computing device 112, is shown. In general, the specification builder page 900 provides the user an interface to view, modify, and generate a product specification data schema from a specific source file received by the provider computing system 104. As shown, the specification builder page 900 includes a next button 902, the sample panel 904, and the interactive sample interface 912. In some embodiments, the specification builder page 900 further includes a document viewer section (not shown), a document selection section (not shown) and/or a definitions section (not shown). In this regard, it should be understood that each of the sections, fields, or buttons of the specification builder page 900 may include data of the product specification data schema and data records described herein.

The back button (not shown) and the next button 902 may be buttons that provide for navigation to the different sections of the specification builder page 900. For instance, the user, via the client computing device 112 may select a document in the document selection section (not shown) and then select the next button 902 to proceed to the interactive sample interface 912.

The sample panel 904 may provide an overview as to the status of the product specification and include a product partition status 906, one or more release statuses 908, and one or more definition statuses 910. Each of the statuses may provide an indication as to which is complete, in-progress or incomplete. For instance, in response to the provider computing system 104 determining a product partition based on the source file, the product partition statuses 906 may go from the first indication (e.g., a red x) to a second indication (e.g., a green check). In another example, in response to the provider computing system 104 determining a product partition, with no assigned events, based on the source file, the product partition status 906 may go from the first indication (e.g., a red x) to a third indication (e.g., a yellow question mark). In some embodiments, each of the statuses may be at least a first indication indicating the data is complete (e.g., the green checkmark), a second indication indicating the data is received but incomplete (e.g., the yellow question mark), and a third indication indicating no data has been received (e.g., the red x).

In some embodiments, the test builder page 800 or the specification builder page 900 may include a document viewer panel or section (not shown) which provides the user an interface to view, modify, and select data a specific source file received by the provider computing system 104. The document viewer section provides the user of the respective client computing device 112 an interface to view the source file and select text data therein to create to indicate the text data is a specific portion of the test specification or product specification (e.g., inputs, results, events, etc., etc.).

The document viewer section may include text data of the source file and one or more indications (e.g., highlights, underline, italicized text, bolded text, a specific marker next to the text, etc.) For instance, the user of the client computing device 112 may select a specific word and/or term of the document viewer section and apply an indication. In some embodiments, the indications may be applied in response to selecting a highlight button (not shown). In this regard, each indication may be associated with a specific field or portion of the test specification or the product specification.

The document viewer section may include comments or markers may correspond to the indications of the text data and provide specific data associated with the indications, such as field or portion of the data with the identifier and the comment 412 (e.g., “reporter email address,” “reporter name,” medical product, adverse event, “external system unique identifier (unique identifier (UID),” worldwide unique identifier (WWUID), etc.), username of the user who generated the indication (e.g., Seth Winslow, system, etc.”), the date/time the indication was generated, the selected text data (e.g., United States of America, etc.). If the provider computing system 104 identified/selected the data from the text data, the comment may include a username associated with the provider computing system 104 (e.g., “system,” “automatic selection,” “system processed,” etc.).

In some embodiments, the indications and the comments may be a specific color based on the associated portion of the test specification or the product specification. For instance, an indication or comment associated with an input of an event may be include the color dark green, an indication or comment associated with a result of an event may include the color purple, and the like.

The embodiments described herein have been described with reference to the drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provision of 35 U.S.C § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexors, registers, capacitors, inductors, diodes, wiring, and so on.

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other embodiments, two or more processors may be coupled via a bus to enable independent, parallel, pipelined, or multi-threaded instruction execution. Each processor may be implemented as one or more general purpose processors, application specific integrated circuits (ASICs), field programmable gate arrays (FPGAs), digital signal processors (DSPs), or other suitable electronic data processing components structured to execute instructions provided by the memory. The one or more processors may take the form of a single core processor, a multi-core processor (e.g., dual core, quad core, etc.), microprocessor, etc. In some embodiments, the one or more processors may be external to the apparatus. For example, the one or more processors may be a remote processor (e.g., a cloud-based processor). Alternatively or additionally, the one or more processors may be internal and/or local to the apparatus. In this regard, a circuit or components thereof may be disposed locally (e.g., as part of a local server, a local computing system) or remotely (e.g., as part of a remote server such as a cloud-based server). To that end, a “circuit” as described herein may include components that are distributed across one or more locations. Further, each of the circuits described herein may be distributed across one or more locations (e.g., each as part of one or more remote servers).

An example system for implementing the overall system or portions of the embodiments might include a general purpose computing device in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile storage media may take the form of ROM, flash memory (e.g., flash memory such as NAND, 3D NAND, NOR, 3D NOR), EEPROM, MRAM, magnetic storage, hard disks, optical disks, etc. Combinations of the above are also included within the scope of machine-readable media. In this regard, machine-executable instructions comprise, for example, instructions and data which cause a general purpose computer, special purpose computer, or special purpose processing machine to perform a certain function or group of functions. Each respective memory device may be operable to maintain or otherwise store data relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claim.

What is claimed is:

1. A method for generating a test specification data schema, the method comprising:
receiving, by a provider computing system, a source file including a linguistic section,
wherein the source file is an unstructured data file type;
parsing, by the provider computing system, the linguistic section to generate structured text data;
determining, by the provider computing system, a first portion of the structured text data identifies a first event;
generating, by the provider computing system, a first request including a query and at least one of: the source file or the structured text data;
outputting, by the provider computing system, the first request to a partner computing system;
receiving, by the provider computing system, an indication of a second event included in a second portion of the structured text data from the partner computing system;
validating, by the provider computing system, the first and second events against a parent event schema;
determining, by the provider computing system, the first event and the second event are complete;
generating, by the provider computing system, a test specification data schema based on the first event and the second event;
storing, by the provider computing system, the test specification data schema in a repository of the provider computing system;
receiving, by the provider computing system, a second request to generate a test specification data record;
selecting, by the provider computing system, the test specification data schema from the repository based on the first request; and
instantiating, by the provider computing system, the test specification data record based on the test specification data schema.

2. The method of claim 1, further comprising:
receiving, by the provider computing system, an application programming interface (API) key,
wherein the first request further includes the API key.

3. The method of claim 1, further comprising:
determining, by the provider computing system, the first event includes at least one first input field, at least first parameter field, and at least one first result field; and
determining, by the provider computing system, the second event includes at least one second input field, at least second parameter field, and at least one second result field,
wherein the provider computing system determines the first event is complete in response to the first event including the at least one first input field, the at least first parameter field, and the at least one first result field, and wherein the provider computing system determines the second event is complete in response to the second event including the at least one second input field, the at least second parameter field, and the at least one second result field.

4. The method of claim 1, wherein the query includes a first text query associated with an input field, a second text query associated with a parameter field, and a third text query associated with a result field.

5. The method of claim 1, further comprising:
outputting, by the provider computing system, the structured text data to a client computing device to enable display on a user interface;
wherein the user interface includes a first section including a first indication the first event is complete in response to determining the first event is complete, wherein the first section further include a second indication the second event is complete in response to determining the second event is complete.

6. The method of claim 5, wherein the first indication and the second indication are each a check mark.

7. The method of claim 5, wherein the user interface further includes a second section including an upload button, and wherein the source file is received in response to a selection of the upload button of the second section.

8. The method of claim 1, wherein the unstructured data file type is at least one of: a portable document format (PDF) file type, an email file type, or a document file type.

9. The method of claim 1, wherein the test specification data record includes a first dependent event data record associated with the first event and a second dependent event data record associated with the second event.

10. The method of claim 1, further comprising:
receiving, by the provider computing system, a parent test specification data schema,
wherein the provider computing system determines the first portion of the structured text data identifies the first event based at least partially on the parent test specification data schema.

11. A method for generating a product specification data schema, the method comprising:
receiving, by a provider computing system, a source file including a linguistic section,
wherein the source file is an unstructured data file type;
parsing, by the provider computing system, the linguistic section to generate structured text data;
selecting, by the provider computing system, at least one test specification data schema from a first repository;
determining, by the provider computing system, a first portion of the structured text data identifies a first product partition;
determining, by the provider computing system, a second portion of the structured text data assigns a first test to the first product partition based on the at least one test specification data schema;
generating, by the provider computing system, a first request including a query and at least one of: the source file or the structured text data;
outputting, by the provider computing system, the first request to a partner computing system;
receiving, by the provider computing system, a first indication of a second product partition included in a third portion of the structured text data from the partner computing system and a second indication of a second test assigned to the second product partition included in a fourth portion of the structured text data;
validating, by the provider computing system, the first and second product partitions against a parent product partition schema;
determining, by the provider computing system, the first product partition and the second product partition are complete;
generating, by the provider computing system, a product specification data schema based on the first product partition, the first test assigned to the first product partition, the second product partition, and the second test assigned to the second product partition;
storing, by the provider computing system, the product specification data schema in a second repository of the provider computing system;
receiving, by the provider computing system, a second request to generate a product specification data record;
selecting, by the provider computing system, the product specification data schema from the second repository based on the second request; and
instantiating, by the provider computing system, the product specification data record based on the product specification data schema.

12. The method of claim 11, further comprising:
receiving, by the provider computing system, an application programming interface (API) key,
wherein the first request further includes the API key.

13. The method of claim 11, further comprising:
wherein the provider computing system determines the first product partition is complete in response to the first test being assigned to the first product partition, and wherein the provider computing system determines the second product partition is complete in response to the second test being assigned to the first product partition.

14. The method of claim 1, wherein the query includes a first text query associated with a product partition and a second text query associated with an assigned test.

15. The method of claim 1, further comprising:
outputting, by the provider computing system, the structured text data to a client computing device to enable display on a user interface;
wherein the user interface includes a first section including a first indication the first product partition is complete in response to determining the first product partition is complete, wherein the first section further include a second indication the second product partition is complete in response to determining the second product partition is complete.

16. The method of claim 15, wherein the first indication and the second indication are each a check mark.

17. The method of claim 15, wherein the user interface further includes a second section including an upload button, and wherein the source file is received in response to a selection of the upload button of the second section.

18. The method of claim 11, wherein the unstructured data file type is at least one of: a portable document format (PDF) file type, an email file type, or a document file type.

19. The method of claim 11, wherein the product specification data record includes a first product partition data record associated with the first partition and a second product partition data record associated with the second product partition.

20. The method of claim 19, further comprising:
selecting, by the provider computing system, a first test specification data schema from the first repository based on the first test;
selecting, by the provider computing system, a second test specification data schema from the second repository based on the second test;
generating, by the provider computing system, a first test specification data record based on the first test specification data schema;
linking, by the provider computing system, the first test specification data record and the first product partition data record;
generating, by the provider computing system, a second test specification data record based on the second test specification data schema; and
linking, by the provider computing system, the second test specification data record and the second product partition data record.
